(19) United States
(12) Patent Application Publication
(10) Pub. No.: US 2026/0093905 A1
(43) Pub. Date: Apr. 2, 2026

(54) INFORMATION PROCESSING APPARATUS, INFORMATION PROCESSING SYSTEM, AND STORAGE MEDIUM

(71) Applicant: Tatsuma HIROKAWA, Kanagawa (JP)

(72) Inventor: Tatsuma HIROKAWA, Kanagawa (JP)

(21) Appl. No.: 19/328,277

(22) Filed: Sep. 15, 2025

(30) Foreign Application Priority Data
Sep. 27, 2024 (JP) 2024-169134

(51) Int. Cl. G06F 40/174; G06V 30/416

(52) U.S. Cl. CPC G06F 40/174; G06V 30/416

(57) ABSTRACT

An information processing apparatus is communicably connected with a server apparatus and a generative AI system via a network. The information processing apparatus includes processing circuitry to display a screen that receives an input of information to an input field of an input item from a user and receives an instruction to extract information to be input to the input field from image data. When the instruction is received, the processing circuitry transmits, to the generative AI system, a request including the image data and an instruction to extract the first information corresponding to the input item from the image data. The processing circuitry receives the first information transmitted from the generative AI system, inputs the first information to the input field of the input item, and transmits the first information input to the input field to the server apparatus to cause the server apparatus to manage the information.

### CROSS-REFERENCE TO RELATED APPLICATIONS

This patent application is based on and claims priority pursuant to 35 U.S.C. § 119(a) to Japanese Patent Application No. 2024-169134, filed on Sep. 27, 2024, in the Japan Patent Office, the entire disclosure of which is hereby incorporated by reference herein.

### BACKGROUND

### Technical Field

The present disclosure relates to an information processing apparatus, an information processing system, and a storage medium.

### Related Art

A technique of analyzing image data using artificial intelligence (AI) and outputting an analysis result has been proposed. An information processing apparatus using AI can output an object captured in image data, classify the image data, and detect an abnormality.

A technique of extracting information such as a name and a company name from image data of a business card and registering the information in a server has been proposed.

### SUMMARY

The present disclosure described herein provides a novel information processing apparatus communicably connected with a server apparatus and a generative AI system via a network. The information processing apparatus includes processing circuitry. The processing circuitry displays a screen that receives an input of information to an input field of an input item from a user and receives an instruction to extract information to be input to the input field from image data. When the instruction is received on the screen, the processing circuitry transmits, to the generative AI system, a request including the image data from which the information is to be extracted and an instruction to extract the information corresponding to the input item from the image data. The processing circuitry receives the information corresponding to the input item transmitted from the generative AI system. The processing circuitry inputs the received information corresponding to the input item to the input field of the input item. The processing circuitry transmits the information corresponding to the input item input to the input field to the server apparatus to cause the server apparatus to manage the information.

The present disclosure described herein provides a novel information processing system including a server apparatus and an information processing apparatus. The information processing apparatus communicates with a generative AI system via a network. The information processing apparatus includes processing circuitry. The processing circuitry displays a screen that receives an input of information to an input field of an input item from a user and receives an instruction to extract information to be input to the input field from image data. When the instruction is received on the screen, the processing circuitry transmits, to the generative AI system, a request including the image data from which the information is to be extracted and an instruction to extract the information corresponding to the input item from the image data. The processing circuitry receives the information corresponding to the input item transmitted from the generative AI system. The processing circuitry inputs the received information corresponding to the input item to the input field of the input item. The processing circuitry transmits the information corresponding to the input item input to the input field to the server apparatus to cause the server apparatus to manage the information.

The present disclosure described herein provides a novel non-transitory storage medium storing computer-readable program code that, when executed by one or more processors on an information processing apparatus communicably connected with a server apparatus and a generative AI system via a network, causes the one or more processors to perform a method. The method comprising: displaying a screen that receives an input of information to an input field of an input item from a user and receives an instruction to extract information to be input to the input field from image data; when the instruction is received on the screen, transmitting, to the generative AI system, a request including the image data from which the information is to be extracted and an instruction to extract the information corresponding to the input item from the image data; receiving the information corresponding to the input item transmitted from the generative AI system; inputting the received information corresponding to the input item to the input field of the input item; and transmitting the information corresponding to the input item input to the input field to the server apparatus to cause the server apparatus to manage the information.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an application creation screen displayed by a user terminal;

FIG. 2 is a diagram illustrating an input screen of a business card management application displayed by a user terminal;

FIGS. 3A to 3D are diagrams illustrating a flow in which a user inputs values to input items of a business card management application;

FIG. 4 is a diagram illustrating a flow of an information setting service performed by an information processing system;

FIG. 5 is a diagram illustrating a system configuration of an information processing system;

FIG. 6 is a diagram illustrating a hardware configuration of an application service, a user terminal, and a developer terminal;

FIG. 7 is a diagram illustrating a functional configuration of an application service and a user terminal;

FIG. 8 is a diagram illustrating information set in input items of an application;

FIG. 9 is a diagram illustrating information on input items of an application;

FIG. 10 is a sequence diagram illustrating a process of an information processing system;

FIG. 11 is a diagram illustrating parameters included in a request message transmitted from a user terminal to a generative AI system in step S8 of FIG. 10;

FIG. 12 is a diagram illustrating a prompt set in “prompt” in FIG. 11;

FIG. 13 is a diagram illustrating a format of a response message transmitted from a generative AI system to a user terminal in step S9 of FIG. 10;

FIG. 14 is a diagram illustrating an input screen of a business card management application displayed by a user terminal;

FIG. 15 is a diagram illustrating a prompt generated by a request generation unit;

FIG. 16 is a diagram illustrating a response message of a generative AI system in response to the request message of FIG. 15;

FIG. 17 is a diagram illustrating an input screen of a business card management application with values set in a business card management application;

FIG. 18 is a diagram illustrating an input screen of a book management application displayed by a user terminal;

FIG. 19 is a diagram illustrating information on input items of a book management application;

FIG. 20 is a diagram illustrating a prompt generated by a request generation unit;

FIG. 21 is a diagram illustrating a response message of a generative AI system in response to a request message of FIG. 20;

FIG. 22 is a diagram illustrating an input screen of a book management application with values set in a book management application;

FIG. 23 is a diagram illustrating a method of setting a value of an input item using a function call function;

FIG. 24 is a diagram illustrating a request message including arguments of a function;

FIG. 25 is a diagram illustrating a response message from a generative AI system in a case where the generative AI system has a function call function;

FIG. 26 is a diagram illustrating an image data selection screen displayed as a part of an input screen of a business card management application or as a pop-up screen;

FIG. 27 is a diagram illustrating information on input items having an input range;

FIG. 28 is a diagram illustrating a prompt for requesting values of input items in JavaScript object notation (JSON) format;

FIG. 29 is a diagram illustrating a request message when a generative AI system has a function call function;

FIG. 30 is a diagram illustrating a prompt using few-shot prompting;

FIG. 31 is a sequence diagram illustrating a process performed by an information processing system when few-shot prompting is used;

FIG. 32 is a diagram illustrating a request message transmitted from a user terminal to a generative AI system; and

FIG. 33 is a diagram illustrating character strings set in “prompt” of FIG. 32.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of an information processing system and a method of setting performed by the information processing system.

An application service is a service that supports creation of an application by a user in low-code or no-code. Such a service is also referred to as visual programming. The application service transmits a web application that supports creation of an application to a user terminal operated by the user. The user can operate the web application executed by the user terminal to create various applications.

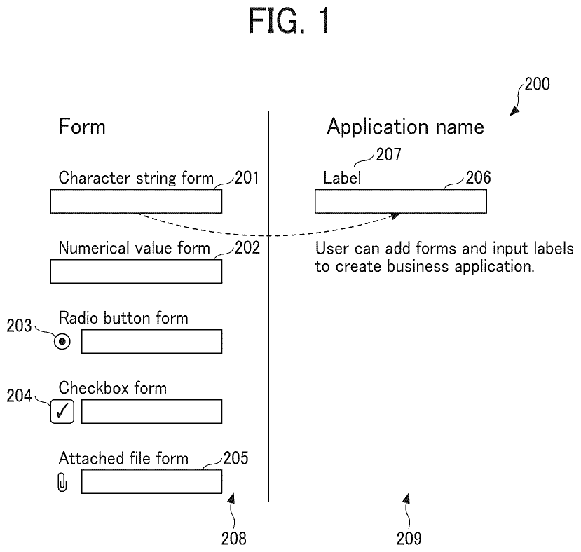

FIG. 1 is a diagram illustrating an application creation screen 200 displayed by the user terminal. The application creation screen 200 includes, for example, a form area 208 and a work area 209. The form area 208 displays a list of forms that can be placed in an application. The form is a display component configuring a screen, and includes, for example, a form for input, a form for selection, and a form for file registration. In FIG. 1, a character string form 201, a numerical value form 202, a radio button form 203, a checkbox form 204, and an attached file form 205 are displayed. The application creation screen 200 described above is an example.

The character string form 201 is a form for inputting a character string. A full-width character, a half-width character, a numerical value, and a symbol can be input to the character string form 201.

The numerical value form 202 is a form for inputting a numerical value. Only numerical values can be input to the numerical value form 202.

The radio button form 203 is a form for a button that receives selection of one option from a plurality of options. The radio button form 203 includes a field for displaying the options.

The checkbox form 204 is a form for a checkbox that receives selection of one or more options from a plurality of options. The checkbox form 204 includes a field for displaying the options.

The attached file form 205 is a form for receiving a setting of a file to be registered in an application. The attached file form 205 may limit the format of files that are accepted for registration.

The work area 209 is an area for the user to place a form. The user operates a mouse pointer to drag and drop the form in the form area 208 into the work area 209. Alternatively, the user operates a touch panel with a finger or a pen to drag and drop the form in the form area 208 into the work area 209.

The form placed in the work area 209 is referred to as an input item 206. The input item 206 includes one or more input fields. The input item 206 may be simply referred to as an input item in the following description. The input item 206 can display a label 207. The label 207 is a name of the input item 206. The user inputs an appropriate label into the input item 206. The user can repeat the operation described above to create any application. For example, the user can place the character string form 201 in the work area 209 and input labels such as a name and a company to create a business card management application described as follows. In the work area 209, the position of the input item 206 that has been already placed can be changed.

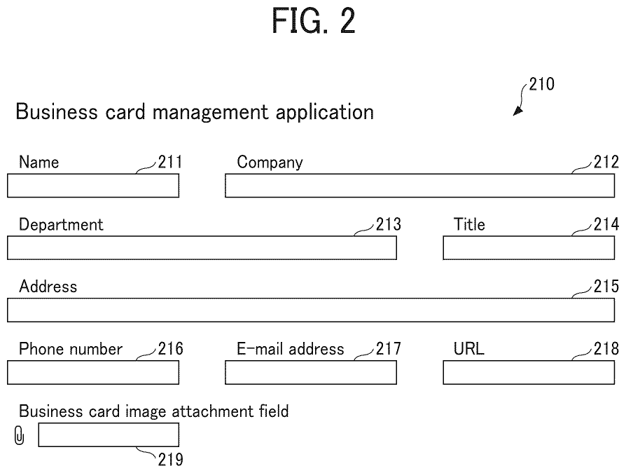

FIG. 2 is a diagram illustrating an input screen 210 of a business card management application displayed by a user terminal. The business card management application includes a name field 211, a company field 212, a department field 213, a title field 214, an address field 215, a phone number field 216, an e-mail address field 217, a uniform resource locator (URL) field 218, and a business card image attachment field 219. These fields are input items. The user can use the application created in this manner for business or personal purposes. For example, in the business card management application, the user inputs information described on a business card received from a customer to each input item described above. This allows the business card management application to digitize the information described on a business card. Alternatively, the business card management application can share digitized information with the team.

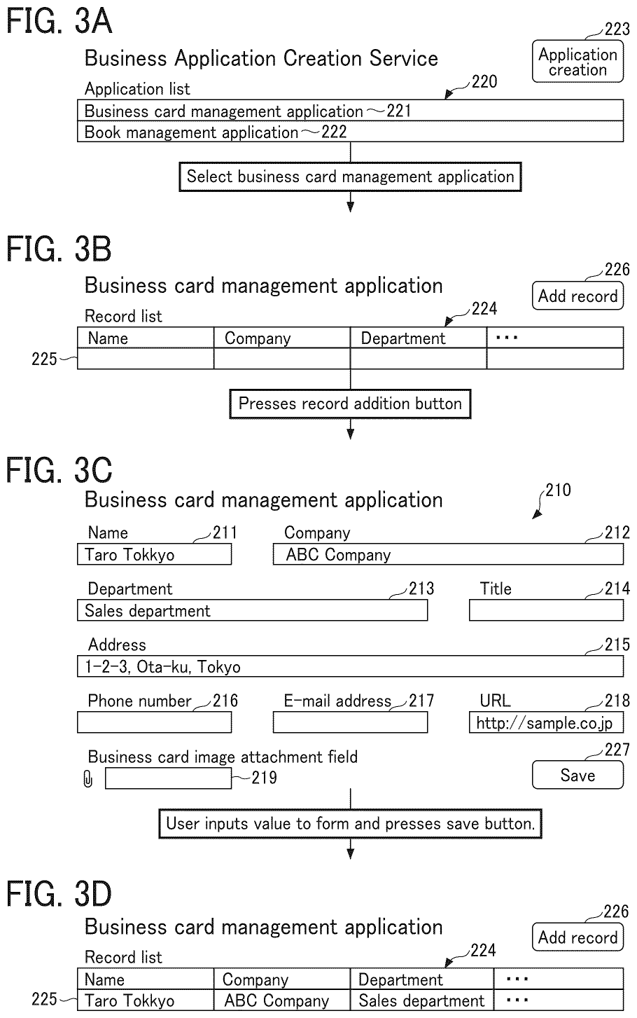

FIGS. 3A to 3D are diagrams illustrating a flow in which a user inputs values to input items of the business card management application. FIG. 3A is a diagram illustrating an application list 220 displayed by a user terminal operated by the user and an application creation button 223. The application list 220 is an application list created and registered in the application service by the user in the procedure illustrated in FIG. 1. For example, a business card management application 221 and a book management application 222 are displayed in the application list 220. In this case, the user selects the business card management application 221. The application creation button 223 is a button that displays the screen illustrated in FIG. 1.

FIG. 3B is a diagram illustrating a record list 224 displayed by a user terminal and a record addition button 226. The record list 224 displays, in a tabular format, a list of business card information registered in the business card management application 221. A record refers to a set of data of single row when data in a database is arranged in a two dimensional table. One record is one piece of business card information. The record list 224 includes a record 225 that includes a plurality of input items. The input items of the record 225 may be referred to as fields. One row of the input items of the record 225 is referred to as a column. In FIG. 3B, since the business card information is not registered, the record list 224 is blank.

When the user presses the record addition button 226, the input screen 210 of the business card management application is displayed. FIG. 3C is a diagram illustrating the input screen 210 of the business card management application. As described above, the input screen 210 of the business card management application 221 includes input items created by the user for the business card management application 221. The user inputs values to the input items and presses a save button 227. The input content (in this case, the business card information) is stored in the application service as a record.

FIG. 3D is a diagram illustrating the record list 224 displayed by a user terminal. In FIG. 3D, the business card information input on the input screen 210 of the business card management application in FIG. 3C is displayed as one record.

As described above, since the user usually inputs data to the input item using the keyboard, the work burden on the user is large. The user may also make erroneous input when the user inputs data.

In the present embodiment, a user terminal transmits a file (image data of a business card) input to the attached file form 205 and a list of input items of the application to a generative AI system, and requests creation of values to be set to the input items. The generative AI system can perform various natural language processing tasks, such as text generation, question answering, text classification, sentiment analysis, information extraction, and sentence summarization. The generative AI system such as Copilot® has been proposed, which suggests next code to be written while coding a program. A description is given below of a technique for extracting information from image data without the user having a conversation (also referred to as a chat) with a generative AI system. In the following description, a generative AI system or a function of the generative AI system may be simply referred to as an AI.

The generative AI system analyzes image data and the list of input items, generates values to be input to the input items, and transmits the values to a user terminal. The generative AI system may be provided as a system different from a system that provides a service related to an application, and a service related to an application and the generative AI system may be provided by the same provider. The user terminal may set the generated values to an application service. The user can use the application service to create not only the business card management application but also any application used by the user in business. Accordingly, the information processing system can generate appropriate values for input items of any application from image data and set the values to input items of an application service.

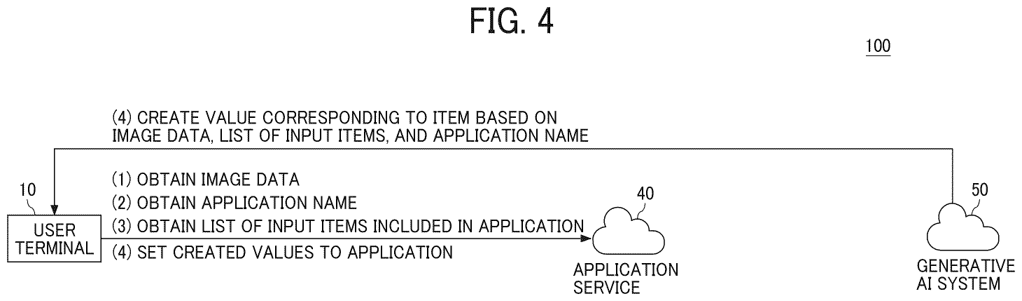

FIG. 4 is a diagram illustrating a process in which an information processing system 100 sets values to an application service 40. The information processing system 100 includes a user terminal 10, the application service 40, and a generative AI system 50. In FIG. 4, a web application is executed in the user terminal 10. The application having input items to which values are to be set is assumed to have already been created in the application service 40. The generative AI system 50 analyzes image data of a business card and a list of input items of the application and generates values to be set to the input items.

In step (1), the user terminal 10 operated by the user obtains image data set from the application service 40. The image data is, for example, image data of a business card, and includes values to be set to input items of the application service 40. In a case where the user terminal 10 stores the image data, the image data may not be obtained from the application service 40.

In step (2), the user terminal 10 obtains an application name to be set to the input item from the application service 40. The application name may not be set, or a document of the application may be obtained instead of the application name. The document of the application is an explanatory text of the application and is set by the user in advance.

In step (3), the user terminal 10 obtains a list of input items included in the application from the application service 40. The steps (1) to (3) described above are not in order, and the user terminal 10 may obtain the information obtained in steps (1) to (3) at the same time.

In step (4), the user terminal 10 transmits the information (the image data, the list of input items, and the application name) related to the application obtained in steps (1) to (3) to the generative AI system 50 and obtains values to be set to the input items. In other words, the generative AI system 50 analyzes the image data, the list of input items, and the application name. The generative AI system 50 recognizes text from the training data and generates features such as the type of image data to generate values corresponding to the input items.

In step (5), the user terminal 10 associates the values obtained from the generative AI system 50 with the input items and transmits the values and the input items to the application service 40 to set values in the input items of the application service 40.

As described above, the information processing system 100 can set values to input items of any application.

An application is an abbreviation of an application program, and is a program generated by a computer in accordance with any business. An operating system (OS) is general-purpose software that provides basic functions and systems (e.g., file system, communication, and display control) in the operation of a computer, whereas the application provides specific functions on the OS. Examples of the application include a native application and a web application. In the present embodiment, either a native application or a web application may be developed.

An application programming interface (API) is an interface of an application (software) and is a contact point for connecting systems to share functions and mechanisms. The API defines a specification of an interface used by applications to exchange information with each other. The API between computers is designed so that one web site communicates with another web site via hypertext transfer protocol (HTTP) or hypertext transfer protocol secure (HTTPS) communication. Communication allows one web site to use the functions of another web site. The API between computers may be referred to as a web-API.

When the API transmits a specific request (e.g., data acquisition, update, deletion, and processing), the API returns a result (e.g., data, an update result, a deletion result, and a processing result) in response to the specific request. The request may be referred to as a request message, and the result may be referred to as a response message. Calling an API indicates transmitting a request and obtaining a result in accordance with the specification of the API. Calling an API may also be referred to as executing, operating, hitting, or using.

The user is an end user who uses an application provided by the application service 40. The user can also develop an application. A developer is a person who performs setting to be used for application development by no-code or low-code programming and use the application on the application service 40.

The input item is each item having an input field for inputting information. The input field can receive various types of input information, and may receive image data, speech data, video data, a file, and information for selecting an option, in addition to a character string, a numerical value, and a symbol.

The information corresponding to the input item is information to be set in the input field of the input item. The information corresponding to the input items is included in, for example, image data. The generative AI system uses a label and a data format of the input items to determine whether the information corresponds to the input items and extracts the information corresponding to the input items from the image data.

### First Embodiment

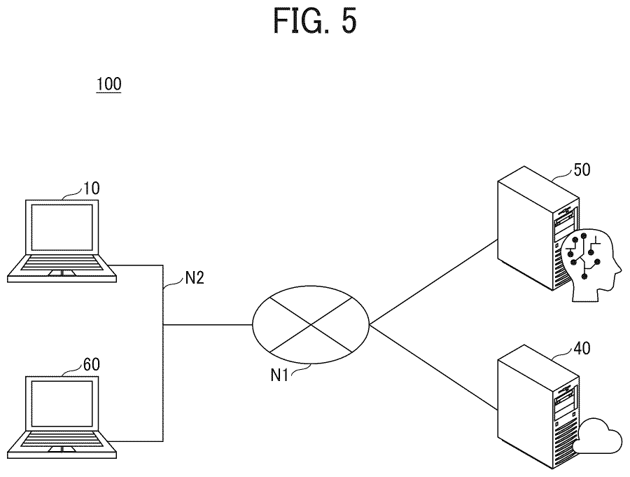

A description is given below of a system configuration of the information processing system 100 with reference to FIG. 5. FIG. 5 is a diagram illustrating the system configuration of the information processing system 100. The information processing system 100 illustrated in FIG. 5 includes the user terminal 10, a developer terminal 60, and the application service 40. The user terminal 10 and the developer terminal 60 are communicably connected to the application service 40 via networks N1 and N2. The information processing system 100 may further include the generative AI system 50. The user terminal 10 and the developer terminal 60 are communicably connected to the generative AI system 50 via the networks N1 and N2. The application service 40 may communicate with the generative AI system 50 via APIs.

The user terminal 10 and the developer terminal 60 are installed in a facility such as a company and a home and are connected to the network N2. The network N2 may be a local area network, a Wi-Fi® network, a wide-area Ethernet®, or a cellular network such as 4G, 5G, or 6G. The network N1 is a wide area network such as the Internet or a wide area network (WAN). The user terminal 10 and the developer terminal 60 may not be always connected to the network N2. The user terminal 10 and the developer terminal 60 may be connected when the generative AI system 50 or the application service 40 is used.

The generative AI system 50 provides a service for the user to converse with an AI in a natural language. As a system such as the generative AI system 50, a system using large language models (LLMs) has been proposed. The LLMs are models for natural language processing that have been trained using a large amount of text data. The generative AI system 50 captures a huge amount of text in advance and learns knowledge from the text using deep learning or reinforcement learning. The generative AI system 50 uses the knowledge to provide a reply message to a chat message. The chat message includes a prompt and image data, which is described later. The prompt is mainly text data in a chat message.

The generative AI system 50 that generates a sentence based on a chat message may be referred to as a generative AI. The values of input items of the application operating in the application service 40 are generated using the response message responded by the generative AI system 50. The application that operates on the application service 40 includes a web application that operates on the application service 40 and a native application that is installed in the user terminal 10. When the native application installed in the user terminal 10 is executed in the user terminal 10, the native application is connected to the application service 40 and executes the function of the application service 40.

The generative AI system 50 has the following features. The generative AI system 50 performs a conversation in a natural flow. The generative AI system 50 can expand ideas even in a field in which the user does not have knowledge to propose. The generative AI system 50 can output accurate program code. The user can utilize such features described above to instruct the generative AI system 50 to provide a list of input items of the application and image data. Thus, the user can receive values to be set to the input items from the generative AI system 50.

A function call function (also referred to as tool_call or function_call) is known as one of the features for enabling the generative AI system 50 to output accurate program code as described above. The generative AI system 50 can be implemented either with or without using the function call function. However, since the tool_call returned by the generative AI system 50 is accurate (has high reproducibility), the possibility that the values of input items are obtained in JSON format increases.

As the generative AI system 50, a system using LLM such as generative pre-trained transformer-3 (GPT-3®), GPT-4®, Transformer®, or bidirectional encoder representations from transformers (BERT®) has been proposed. The information processing system 100 can use ChatGPT using GPT-3® or GPT-4®. Alternatively, the information processing system 100 may use a system using another LLM.

The application service 40 is one or more information processing apparatuses that provide an application to be executed by the user. The application service 40 is a server apparatus that provides an application for managing information input to the input fields of input items by the user. The application provided by the application service 40 is, for example, a database type web application that manages data in a table format. The user can create any input items of an application and can customize the application so that the user can store, read, or process data related to the customer's business.

The user terminal 10 obtains information on an application from the application service 40. The user terminal 10 transmits information on an application to the generative AI system 50 to receive a response message (input items and values of input items) from the generative AI system 50. The user terminal 10 transmits the input items and the values of input items to the application service 40. Accordingly, the user can automatically set information to be manually input from image data in the application.

The application service 40 is, for example, a cloud service, an application service provider (ASP), and a software as a service (SaaS), and may include various services provided via a network. The services provided via a network are, for example, a database provision service and a storage service. The application service 40 may be deployed in the Internet. Alternatively, the application service 40 may be deployed in an on-premises environment.

The application service 40 may have its functions distributed across multiple information processing apparatuses. Alternatively, multiple application services 40 having the same function may be deployed, and the number of information processing apparatuses that performs video streaming may be increased or decreased depending on the processing load.

A web server may exist separately from the application service 40, and the web server may communicate with the user terminal 10. In this case, the user terminal 10 communicates with the generative AI system 50 in the same manner. However, the web server communicates with the application service 40 instead of the user terminal 10.

The server is a computer or software that functions to provide information or a processing result in response to a request from the client.

The application service 40 receives various settings from the developer terminal 60. The various settings include user registration to the application service 40 and registration of a web application for creating a chat message. In other words, an administrator uses the generative AI system 50 to set values to input items of an application on the application service 40.

The user terminal 10 or the developer terminal 60 is, for example, a terminal device (an example of information processing apparatus) such as a personal computer (PC), a smartphone, or a tablet terminal used by the user or the developer. In the user terminal 10 or the developer terminal 60, a web browser or a native application operates. The developer operates the developer terminal 60 to create setting information on the application. The administrator or the user can operate the developer terminal 60 and the user terminal 10 to use various services provided by the generative AI system 50 or the application service 40.

The user terminal 10 or the developer terminal 60 may be any information processing apparatus. Such an information processing apparatus includes an output apparatus such as an electronic whiteboard or a digital signage. Such an information processing apparatus also includes a head up display (HUD) apparatus, an industrial machine, an imaging apparatus, a sound collecting apparatus, a medical apparatus, a network home appliance, a mobile phone, a smartphone, a tablet terminal, a car navigation system, a game machine, a personal digital assistant (PDA), a digital camera, and a wearable PC.

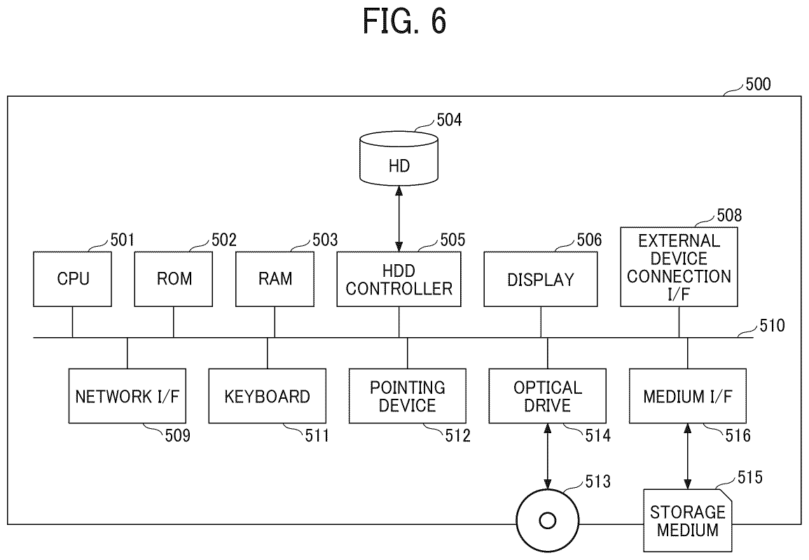

A description is given below of a hardware configuration of the application service 40, the user terminal 10, and the developer terminal 60 included in the information processing system 100 with reference to FIG. 6. The generative AI system 50 has the same hardware configuration described in FIG. 6, or has a hardware configuration of an information processing apparatus compatible with cloud computing.

FIG. 6 is a diagram illustrating the hardware configuration of the application service 40, the user terminal 10, and the developer terminal 60. As illustrated in FIG. 6, the application service 40, the user terminal 10, and the developer terminal 60 each are implemented by a computer 500. The computer 500 includes a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a medium I/F 516.

The CPU 501 controls the overall operation of the computer 500. The ROM 502 stores programs such as an initial program loader (IPL) to boot the CPU 501. The RAM 503 is used as a work area for the CPU 501. The HD 504 stores various data such as a program. The HDD controller 505 controls the reading and writing of various data from and to the HD 504 under the control of the CPU 501. The display 506 displays various information such as a cursor, a menu, a window, a character, or an image. The external device connection I/F 508 is an interface for connecting the computer 500 to various external devices. In this case, the external devices include, but not limited to, a universal serial bus (USB) memory and a printer. The network I/F 509 is an interface for performing data communication using the network N2. Examples of the bus line 510 include, but are not limited to, an address bus and a data bus, which electrically connects the elements such as the CPU 501 illustrated in FIG. 6 with each other.

The keyboard 511 is an example of an input device (input method) including a plurality of keys used to input characters, numerals, or various instructions, for example. The pointing device 512 is an example of an input device (input method) that allows the user to select or execute various instructions, select an item to be processed, or move a cursor being displayed. The optical drive 514 controls the reading or writing of various data with respect to an optical storage medium 513, which is a removable storage medium. The optical storage medium is, for example, a digital versatile disc (DVD) or a compact disk (CD). The medium I/F 516 controls the reading and writing (storing) of data from and to a storage medium 515 such as a flash memory.

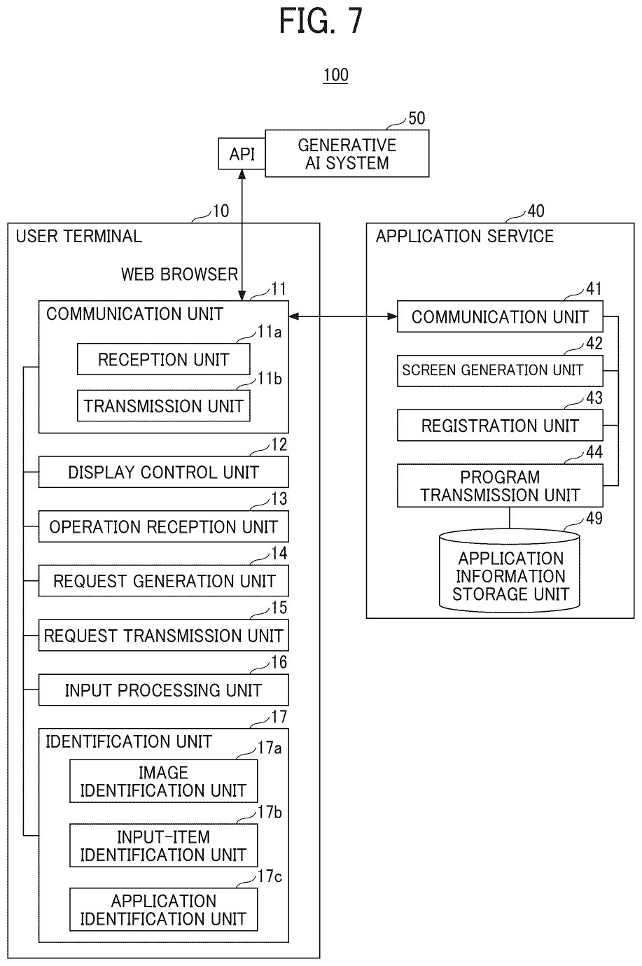

A description is given below of a functional configuration of the information processing system 100 with reference to FIG. 7. FIG. 7 is a diagram illustrating the functional configuration of the application service 40 and the user terminal 10.

The user terminal 10 includes a communication unit 11, a display control unit 12, an operation reception unit 13, a request generation unit 14, a request transmission unit 15, an input processing unit 16, and an identification unit 17. These functional units are functions or methods that are implemented by the CPU 501 illustrated in FIG. 6 executing instructions included in one or more programs installed on the user terminal 10. For example, the communication unit 11, the display control unit 12, the operation reception unit 13, the request generation unit 14, the request transmission unit 15, the input processing unit 16, and the identification unit 17 may be implemented by a web browser and a web application. The web application is transmitted from the application service 40 to the user terminal 10. The communication unit 11, the display control unit 12, the operation reception unit 13, the request generation unit 14, the request transmission unit 15, the input processing unit 16, and the identification unit 17 may be implemented by a native application when the user terminal 10 executes the native application.

The communication unit 11 transmits and receives various types of information to and from the application service 40 and the generative AI system 50. The communication unit 11 includes a reception unit 11a and a transmission unit 11b. The reception unit 11a receives information on an application from the application service 40. The transmission unit 11b transmits information on the application to the generative AI system 50. The reception unit 11a receives values to be set in input items from the generative AI system 50. The generative AI system 50 publishes an API, and the transmission unit 11b calls the API to transmit a request message including a chat message to the generative AI system 50. As described above, the request message is information including a chat message. A request message is a general name of HTTP communication, and the chat message may also be referred to as a request message.

The display control unit 12 interprets screen information of various screens to display screens on the display 506. The operation reception unit 13 receives various operations of the user on the various screens displayed on the display 506.

The request generation unit 14 generates a request message for calling the API published by the generative AI system 50. The request message requests the generative AI system 50 to generate information. The request message includes a text portion referred to as a prompt and image data (which may be image data itself or a URL). The request message may also include speech data.

The request transmission unit 15 transmits a request including image data and an instruction to extract values corresponding to the input items from the image data to the generative AI system 50. This request is a request message generated by the request generation unit 14.

The input processing unit 16 inputs values corresponding to the input items transmitted from the generative AI system 50 to the input fields of input items.

The identification unit 17 identifies the image data uploaded to the generative AI system 50 as the image data to be extracted. The identification unit 17 further receives information for identifying the application selected by the user from the generative AI system 50 and identifies the input items based on the information for identifying the application.

The identification unit 17 includes an image identification unit 17a, an input-item identification unit 17b, and an application identification unit 17c. The image identification unit 17a identifies image data uploaded by the user. The input-item identification unit 17b identifies an input item corresponding to an application. The application identification unit 17c identifies an application name of an application.

The application service 40 includes a communication unit 41, a screen generation unit 42, a registration unit 43, a program transmission unit 44, and an application information storage unit 49. The functional units of the application service 40 are functions or methods implemented by the CPU 501 illustrated in FIG. 6 executing instructions included in one or more programs installed in the application service 40. The application information storage unit 49 is implemented in the HD 504 or the RAM 503 illustrated in FIG. 6. The application information storage unit 49 may not be included in the application service 40 and may be on a network that can be accessed by the application service 40.

The communication unit 41 transmits and receives various kinds of information to and from the user terminal 10. The communication unit 41 transmits information on an application to the user terminal 10 in response to a request from the user terminal 10. The communication unit 41 transmits a web application to be executed by the user terminal 10 and screen information to be displayed by the web application to the user terminal 10.

The screen generation unit 42 generates screen information to be displayed on a screen of the user terminal 10. The screen information is a program written in hypertext markup language (HTML), JSON format, extensible markup language (XML), script language, or cascading style sheet (CSS), and may be referred to as a web application. The structure of a web page is mainly specified by the HTML, the operation of the web application is specified by a script language, and the style of the web page is specified by CSS. The user terminal 10 may execute a native application. The native application is an application that is installed and executed on the user terminal 10. In the case of the native application, the user terminal 10 includes the configuration information of screen and the information to be displayed is transmitted in JSON or XML.

The registration unit 43 manages application information in the application information storage unit 49 for each application. The registration unit 43 registers the values corresponding to the input items transmitted from the user terminal 10 in the application information storage unit 49. The application information includes information set in the input items of the application and information on the input items of the application.

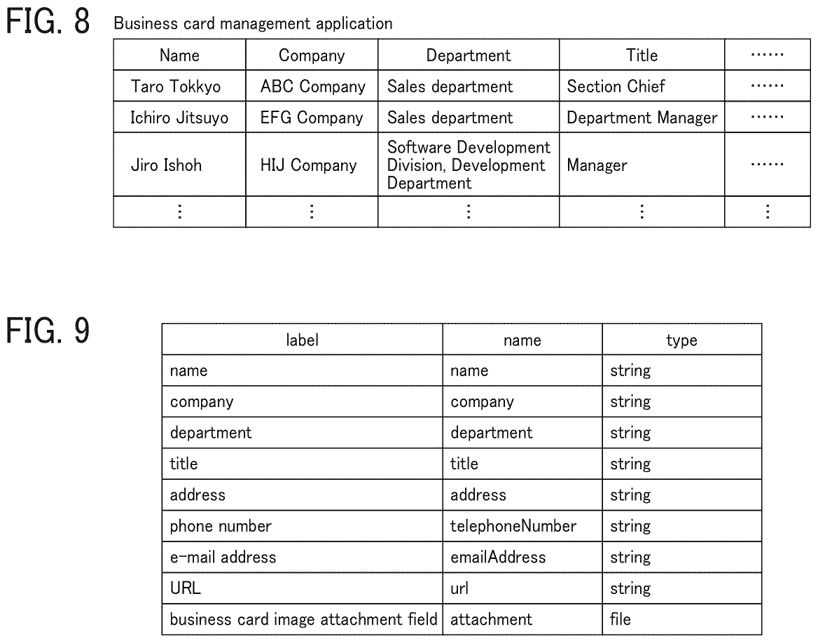

The application information storage unit 49 stores the information set in the input items of the application and the information on the input items of the application (see FIGS. 8 and 9).

The program transmission unit 44 transmits a program to the user terminal 10 in response to a request for the program transmitted from the user terminal 10. The program transmitted by the program transmission unit 44 is a web application, and is, for example, written in JavaScript® included in the web application.

FIG. 8 is a diagram illustrating the information set in the input items of the application. The information set in the input items of the application includes information manually set by the user and information generated by the generative AI system 50. FIG. 8 is a diagram illustrating the information set in the input items of the business card management application as an example. The information set in the input items is managed in units of records. In the case of the business card management application, information of one record is referred to as business card information. In this case, the input items include a name, a company, a department, and a title, and values of input items are stored for each input item.

FIG. 9 is a diagram illustrating the information on the input items of the application. The information on the input items of the application defines what kind of information is stored in each input item.

An item label of FIG. 9 is a name (so-called label) of the input item displayed on the input screen 210 of the business card management application.

An item name of FIG. 9 is identification information of the input item used by the application service 40 for management and identification of the input item.

An item type of FIG. 9 is a data format of the input item.

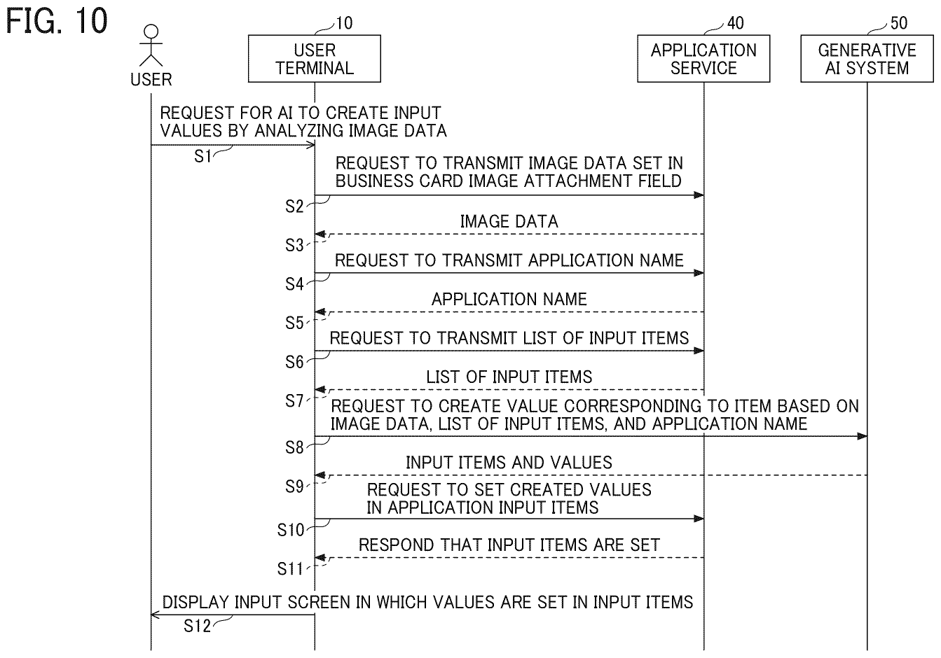

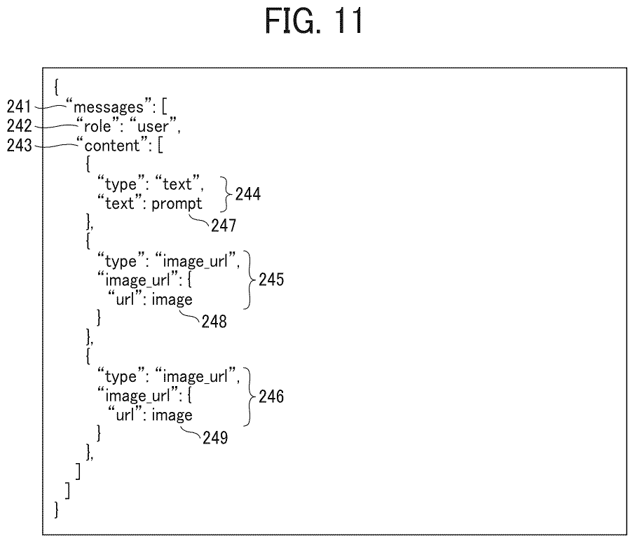

A description is given below of an overall process performed by the information processing system 100 with reference to FIG. 10. FIG. 10 is a sequence diagram illustrating the process of the information processing system 100. Before the process of FIG. 10 is started, the business card management application is assumed to have already been registered in the application service 40. It is also assumed that image data of a business card is set in the application service 40, but no value is set in the other input items.

In step S1, the user terminal 10 displays the input screen 210 of the business card management application. When the input screen 210 of the business card management application is implemented by a web application, the transmission unit 11b transmits a request for one or more programs to be executed by the user terminal 10 to the application service 40. The program transmission unit 44 of the application service 40 transmits a web application to the user terminal 10. The web application includes a program. The program displays a screen that receives an input of a value to an input field from the user. The screen can receive an instruction to extract information to be input to the input field from image data. When the instruction is received on the screen, the program transmits a request including image data to be extracted and an instruction to extract values corresponding to input items from the image data to the generative AI system 50. The program receives the values corresponding to the input items transmitted from the generative AI system 50. The program inputs the received values to the input fields of the corresponding input items. The program transmits the values input to the input fields to the application service 40 in order to manage the values input to the input fields by the application service 40.

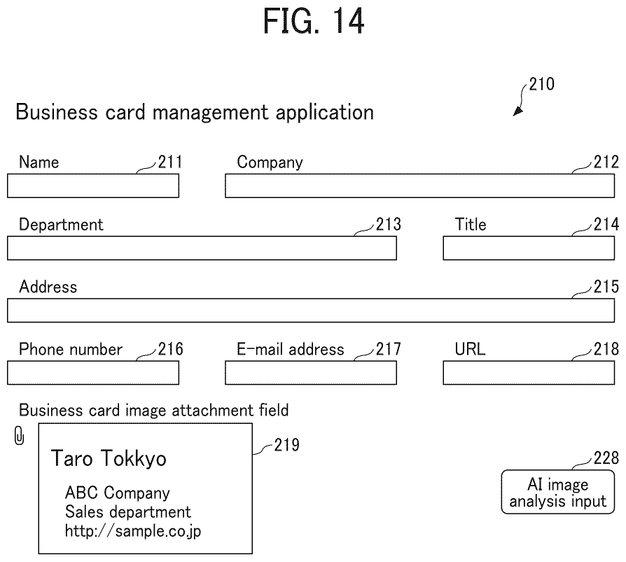

The input screen 210 of the business card management application displays image data (thumbnail) of a business card in the business card image attachment field 219 as illustrated in FIG. 14 described below. The user presses an AI image analysis input button 228 to start an AI image analysis input. The operation reception unit 13 of the user terminal 10 receives this operation. The AI image analysis input is a series of processes of analyzing image data to generate values of input items and setting the values in the application service 40.

In step S2, in response to this operation, the communication unit 11 of the user terminal 10 specifies the identification information of the application and the record identification (information for identifying the record) being displayed and requests the application service 40 to provide the image data set in the business card image attachment field 219.

In step S3, the communication unit 41 of the application service 40 receives the request from the communication unit 11 of the user terminal 10. The registration unit 43 obtains the original image data displayed in the business card image attachment field 219 specified by the record identification from the application information specified by the identification information of the application. The communication unit 41 of the application service 40 transmits the image data set in the business card image attachment field 219 to the user terminal 10.

The reception unit 11a of the user terminal 10 receives the original image displayed in the business card image attachment field 219. When the image data of the business card is not set in the application service 40, the image data of the business card stored in the HD 504 of the user terminal 10 may be used, and the image data of the business card may not be obtained from the application service 40.

In step S4, subsequently, the communication unit 11 of the user terminal 10 specifies identification information of the application to request the application service 40 to provide the application name. Since the application being displayed by the user terminal 10 is identified, the identification information of the application is known. When values are set to input items of an application that is not being displayed by the user terminal 10, for example, the user selects the application. Since the accuracy of generating appropriate values for input items is enhanced by analyzing the application name with the generative AI system 50, the application name is requested. Accordingly, the application name may not be used. The user terminal 10 may request a document of the application instead of the application name. The document of the application includes an explanatory text of the application, for example, “this application is an application that manages business cards.”

In step S5, the communication unit 41 of the application service 40 receives the request, and the registration unit 43 obtains the application name from the application information identified by the identification information of the application. The communication unit 41 of the application service 40 transmits the application name to the user terminal 10. The reception unit 11a of the user terminal 10 receives the application name.

In step S6, subsequently, the communication unit 11 of the user terminal 10 specifies the identification information of the application to request the application service 40 to provide a list of input items. Specifically, since the item label is appropriate as an input item used by the generative AI system 50, the reception unit 11a receives a list of the item label.

In step S7, the communication unit 41 of the application service 40 receives the request, and the registration unit 43 obtains a list of input items from the information on the input items identified by the identification information of the application. The communication unit 41 of the application service 40 transmits the list of input items to the user terminal 10. The reception unit 11a of the user terminal 10 receives the list of input items.

In step S8, subsequently, the request generation unit 14 of the user terminal 10 generates a request message using the information on the application. The information on the application includes image data of the business card, the application name, and the list of input items. The request message includes an instruction to extract information corresponding to the input items from the image data. The request transmission unit 15 transmits a generation request of the values of the input items to the generative AI system 50 together with the request message. FIG. 11 indicates a description of the request message.

In step S9, the generative AI system 50 analyzes the image data of the business card to generate the values of the input items and determines which input item the value corresponds to. The generative AI system 50 transmits a response message to the user terminal 10. The response message includes the input items and the generated values. The reception unit 11a of the user terminal 10 receives the input items and the generated values.

In step S10, subsequently, the communication unit 11 of the user terminal 10 generates a request message for requesting setting of the input items and the generated values to the application. The transmission unit 11b transmits the request message to the application service 40.

In step S11, the communication unit 41 of the application service 40 receives the request message, and the registration unit 43 of the application service 40 stores (registers) the values in the application information storage unit 49 in association with the input items. The communication unit 41 of the application service 40 notifies the user terminal 10 that the registration of the values has been completed. The reception unit 11a of the user terminal 10 receives the notification that the registration of the values has been completed.

In step S12, the transmission unit 11b of the user terminal 10 transmits a request for updating the screen to the application service 40. The reception unit 11a of the user terminal 10 receives the latest application information. Then, the input processing unit 16 of the user terminal 10 inputs the values corresponding to the input items into the respective input fields of those input items. The display control unit 12 displays the input screen 210 of the business card management application in which the values are set in the input items.

FIG. 11 is a diagram illustrating parameters included in a request message transmitted from the user terminal 10 to the generative AI system 50 in step S8 of FIG. 10.

The request message includes a “messages” key 241, a “role” key 242, a “content” key 243, and parameters 244 to 246. The “messages” key 241 is an API of the generative AI system 50 and indicates that the following is a chat message.

The “role” key 242 is an API of the generative AI system 50 and is a classification of a request source of the request message. The classification includes a user, an assistant (AI of the generative AI system 50), and a system (instructing setting of AI assistant).

The “content” key 243 is an API of the generative AI system 50, and a dialogue sentence is set in the “content” key 243. Since the content has an array structure, a prompt and a plurality of image data can be specified. In FIG. 11, the parameters 244 to 246 are described in JSON format. The parameters 245 and 246 include image data.

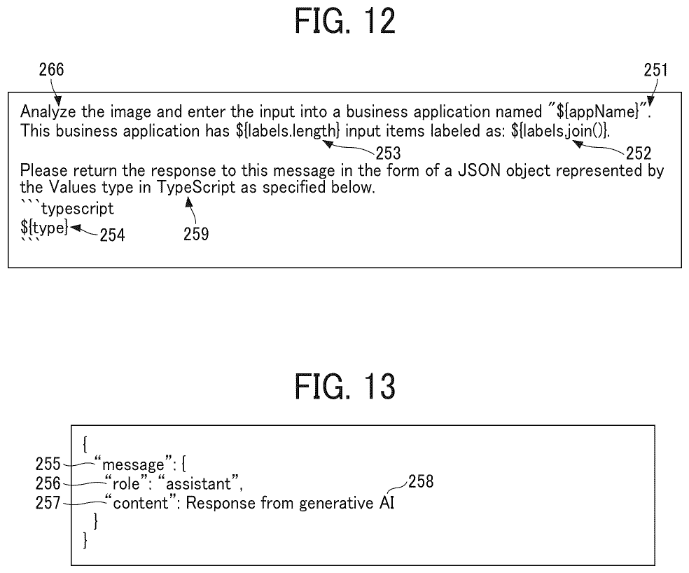

The parameters 244 to 246 are in a format of information to be transmitted to the generative AI system 50. Each of the parameters 244 to 246 includes a “type” key. The “type” key defines the data type. When the “type” key is set to “text,” the value of “text” is a “prompt” 247. A prompt is set in the “prompt” 247. An example of the prompt set in the “prompt” 247 is illustrated in FIG. 12. When the “type” key is set to “image_url”, the values of the “image_url” are an “image” 248 and an “image” 249. A URL or a Base64-encoded image is set to the “image” 248 and the “image” 249. When the application includes one input item of image data, either parameter 245 or 246 is sufficient.

As illustrated in FIG. 11, a request message including a prompt and image data is transmitted to the generative AI system 50.

FIG. 12 is a diagram illustrating a prompt set in the “prompt” 247 in FIG. 11. The character strings in FIG. 12 are templates used by the request generation unit 14 to generate a prompt. The character strings collectively include four placeholders in the form of ${ . . . }. When the request message is sent, information on the application is set in placeholders ${appName} 251, ${labels.join( )} 252, ${labels.length} 253, and ${type} 254. In other words, the four placeholders in the form of ${ . . . } are replaced with information on the application. The other character strings are fixed sentences and are stored in advance by the request generation unit 14. The prompt includes a phrase “analyze the image” 266, a placeholder ${appName} 251, a placeholder ${labels.join( )} 252, a placeholder ${labels.length} 253, a placeholder ${type} 254, and a “TypeScript” 259. The phrase “analyze the image” 266 at the beginning of the prompt requests analysis of the image data specified by the parameter 245 included in the request message.

An application name is set in the placeholder ${appName} 251. The application name may be omitted or may be a document of the application. The document of the application describes what the application is.

A list of the input items is set in the placeholder ${labels.join( )} 252.

The number of the input items is set in the placeholder ${labels.length} 253.

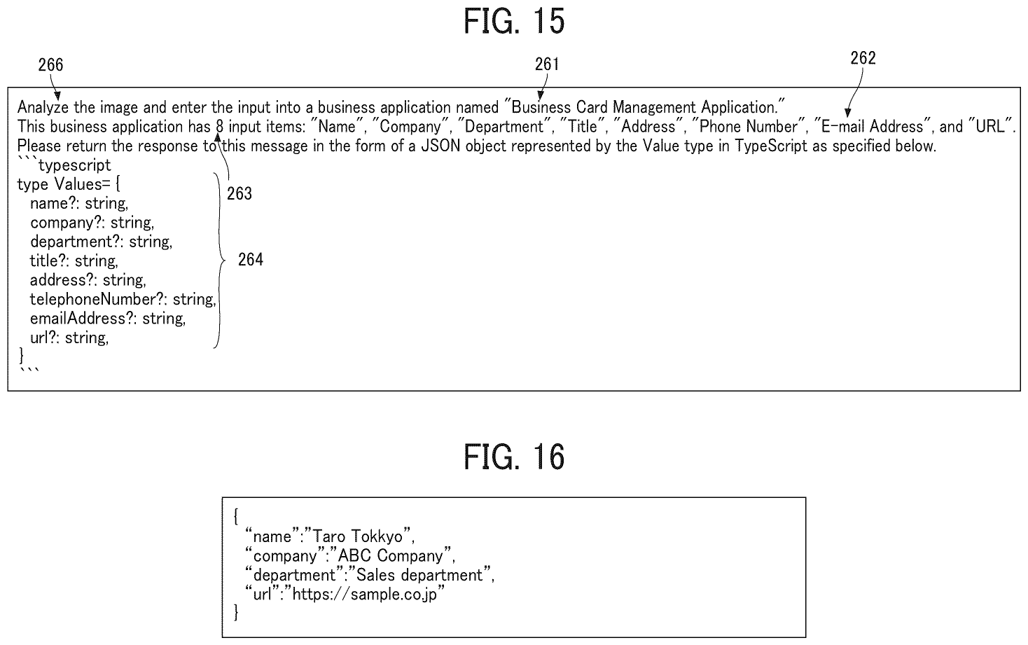

A data format of the input items to be returned by the response message is set in the placeholder ${type} 254. The “TypeScript” 259 is a statically typed programming language that allows data types of variables to be declared in the code. In FIG. 12, JSON format is specified in the placeholder ${type} 254. In other words, the prompt in FIG. 12 instructs the generative AI system 50 to return the input items and the values in JSON format. Details of the specific setting are described later with reference to FIG. 15.

FIG. 13 is a diagram illustrating a format of the response message transmitted from the generative AI system 50 to the user terminal 10 in step S9 of FIG. 10. The response message of FIG. 13 includes a “messages” key 255, a “role” key 256, a “content” key 257, and a “response” key 258. In other words, FIG. 13 illustrates the format of the response message, rather than the message itself.

The “messages” key 255 indicates that the following is a response message:

The “role” key 256 is a classification of a transmission source that transmits the response message. In this case, the “role” key 256 is “assistant” (AI of the generative AI system 50).

The “content” key 257 is the content of the response message. In this case, the “content” key is the response 258 (input items and values) from the generative AI system 50. Details of the response 258 from the generative AI system 50 are described later with reference to FIG. 16.

In the following description, a description is given below of setting values to input items using image data, using the business card management application and the book management application.

A description is given below of the setting values to the input items of the business card management application with reference to FIG. 14. FIG. 14 is a diagram illustrating the input screen 210 of the business card management application displayed by the user terminal 10. The description given in reference to FIG. 14 mainly describes the differences from FIG. 2. In FIG. 14, the user inputs image data of a business card in the business card image attachment field 219. The user can manually input values to the input fields of the input screen 210 of the business card management application.

In FIG. 14, a thumbnail of image data of a business card is displayed in the business card image attachment field 219. In this state, the user presses the AI image analysis input button 228. The AI image analysis input button 228 receives an instruction to extract values to be input to input items from the image data. The AI image analysis input button 228 may be enabled (can be pressed) when the image data of the business card is input to the business card image attachment field 219.

A description is given below of information on an application of the business card management application. The application name of the business card management application is a “business card management application.” According to the information on the input items in FIG. 9, the list of the input items (item label) includes a name, a company, a department, a title, an address, a phone number, an e-mail address, a URL, and a business card image attachment field. Among these input items, the business card image attachment field does not need the AI image analysis input. Accordingly, the request generation unit 14 does not need to include the business card image attachment field in the prompt. The request generation unit 14 includes, in the prompt, only the input items in which the item type of the information on the input items is the “string” type. Thus, the request generation unit 14 can exclude, from the prompt, the input item in which the input of the value is not necessary. Accordingly, the list of input items includes the name, the company, the department, the title, the address, the phone number, the e-mail address, and the URL. The number of input items is eight.

The input screen 210 of the business card management application is a screen for uploading image data. The identification unit 17 identifies the uploaded image data as an image from which values are to be extracted. The reception unit 11a receives information for identifying the application selected by the user, and the identification unit 17 identifies the input items based on the information for identifying the application (using the information on the input items in FIG. 9). The image identification unit 17a identifies the image data uploaded by the user. The input-item identification unit 17b identifies the input items corresponding to the application. The application identification unit 17c identifies the application name of the application.

FIG. 15 is a diagram illustrating a prompt generated by the request generation unit 14. The prompt includes a phrase “business card management application” 261, a phrase “name, company, department, title, address, phone number, e-mail address, and URL” 262, a value “8” 263, and a data format 264. The following information is set in the placeholder ${appName} 251, the placeholder ${labels.join( )} 252, and the placeholder ${labels.length} 253 illustrated in FIG. 12.

The phrase “business card management application” 261 is set in the placeholder ${appName} 251.

The phrase “name, company, department, title, address, phone number, e-mail address, and URL” 262 is set in the placeholder ${labels.join( )} 252. In other words, the item label of the information on the input items is set. Since the item name is typically identification information, and information that is not related to the label (i.e., it is difficult for the generative AI system 50 to determine what input item) is often set in the item name, the item name is not set.

The value “8” 263 is set in the placeholder ${labels.length} 253.

The data format 264 of each input item is set in the placeholder ${type} 254 illustrated in FIG. 12. The data format 264 is an instruction to extract information described in this data format.
“name?: string,
company?: string,
department?: string,
title?: string,
address?: string,
telephoneNumber?: string,
emailAddress?: string,
url?: string”

The instructions described above are the values of the item name and the item type in the information on the input items in FIG. 9. The item name of the data format 264 is arranged in the same order as the phrase “name, company, department, title, address, phone number, e-mail address, and URL” 262.

Since the user terminal 10 transmits the values of the input items returned by the generative AI system 50 to the application service 40, the item name of the data format 264 is not the item label. The application service 40 identifies the input items using the values of the item name, not using the values of the item label. However, the values of the item label may be used. In this case, the request generation unit 14 converts the item label into the item name when values are set to the application service 40.

The symbol “?” at the end of the item name indicates that the generative AI system 50 may omit an input item when there is an input item whose value is not found in the image data. The “string” of the data format 264 is a value (data type) of the item type.

The generative AI system 50 interprets that the image data specified by the parameter 245 included in the request message is to be analyzed, by the phrase “analyze the image” 266 at the beginning of the prompt. Subsequently, the generative AI system 50 attempts to generate the values of the phrase “name, company, department, title, address, phone number, e-mail address, and URL” 262 from the image data. Subsequently, the generative AI system 50 determines the input item for which the value has been generated based on the arrangement order of the data format 264, and associates the input item with the generated value.

FIG. 16 is a diagram illustrating the response message of the generative AI system 50 in response to the request message of FIG. 15. The generative AI system 50 analyzes the image data of the business card to obtain values corresponding to the phrase “name, company, department, title, address, phone number, e-mail address, and URL” 262. Then, the generative AI system 50 returns the values in association with the item name (described “input item” in the following description) included in the data format 264 of the prompt.
input item: Value
name: Taro Tokkyo
company: Sample 1 corporation
department: Sales department
URL: https://sample.co.jp

In this case, since the title, the address, the phone number, and the e-mail address among the input items included in the data format 264 of the prompt are not included in the image data of the business card or the generative AI system 50 cannot detect this information from the business card, this information is not included in the request message.

The user terminal 10 uses the response message of FIG. 16 to request the application service 40 to set the values obtained from the generative AI system 50 in the business card management application.

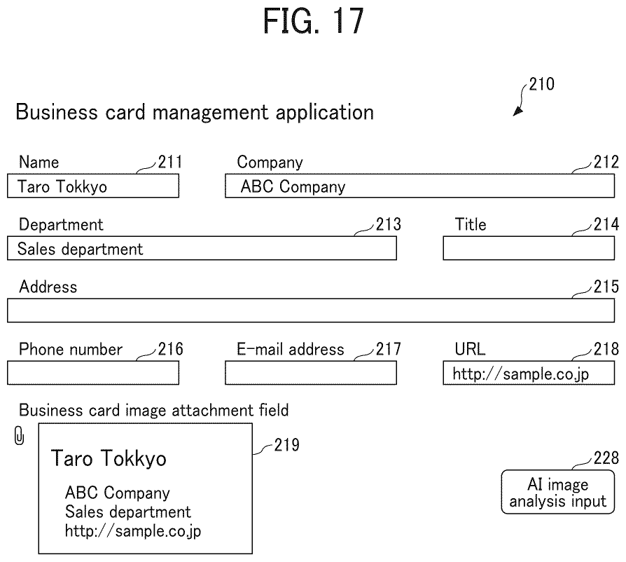

FIG. 17 is a diagram illustrating the input screen 210 of the business card management application with the values set in the business card management application. The input processing unit 16 inputs the values corresponding to the input items into the respective input fields of those input items. In other words, the values included in the response message are set in the corresponding input items, respectively. The values generated by the generative AI system 50 are set in the name field 211, the company field 212, the department field 213, and the URL field 218.

The values input to the input items by the input processing unit 16 can be manually edited by the user. When the user presses a button for registration on the input screen 210 of the business card management application, the process of step S10 in FIG. 10 is executed.

As described above, the user can specify the image data of the business card to automatically set the value obtained by analyzing the image data of the business card to the corresponding input items. Since the user terminal 10 obtains information on an application from the application service 40, the user terminal 10 can also set appropriate values extracted from image data to input items of any application that is not limited to the business card management application.

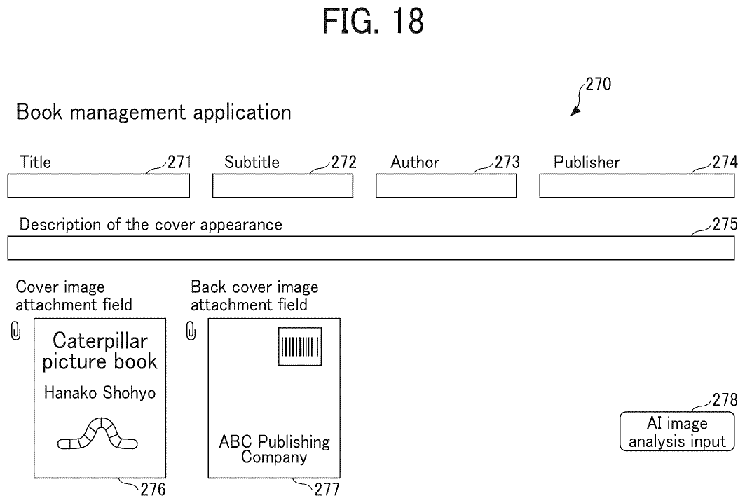

A description is given of a process of setting values to input items of a book management application with reference to FIG. 18. FIG. 18 is a diagram illustrating an input screen 270 of the book management application displayed by the user terminal 10. The book management application includes a title field 271, a subtitle field 272, an author field 273, a publisher field 274, a description of cover appearance 275, a cover image attachment field 276, a back cover image attachment field 277, and an AI image analysis input button 278. These fields are input items. The user can use the book management application for business or personal use. For example, the user inputs information on books that the user has purchased or finished reading into the input items of the book management application. As a result, the user can digitize and list the information on the books that the user has purchased or finished reading.

In order to set values to input items using the generative AI system 50, the user inputs image data of a book to the cover image attachment field 276 and the back cover image attachment field 277. A thumbnail of image data of a cover of the book is displayed in the cover image attachment field 276. The back cover image attachment field 277 displays a thumbnail of image data of a back cover of the book. Only one of the cover image attachment field 276 and the back cover image attachment field 277 may be input.

In this state, the user presses the AI image analysis input button 278. The AI image analysis input button 278 may be enabled (can be pressed) when image data is input to at least one of the cover image attachment field 276 and the back cover image attachment field 277.

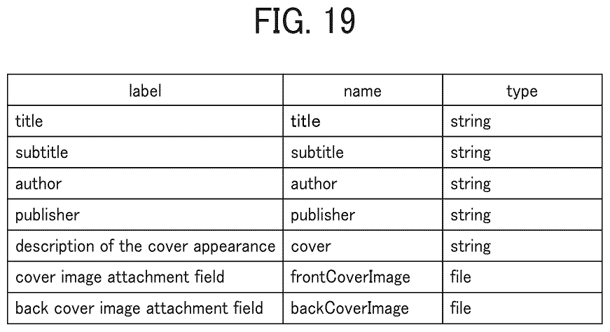

FIG. 19 is a diagram illustrating information on the input items of the book management application. Similarly to the information on the input items of the business card management application (FIG. 9), the information on the input items of the book management application includes an item label, an item name, and an item type.

A description is given below of the information on the book management application. The application name of the book management application is “book management application.” According to the information on the input items in FIG. 19, the list of the input items (item label) is a title, a subtitle, an author, a publisher, a description of cover appearance, a cover image attachment field, and a back cover image attachment field. Among the input items described above, the AI image analysis input does not need the cover image attachment field and the back cover image attachment field. Accordingly, the request generation unit 14 does not need to include the cover image attachment field and the back cover image attachment field in the prompt. The request generation unit 14 includes, in the prompt, only the input items in which the item type of the information on the input items is the “string” type. Thus, the request generation unit 14 can exclude, from the prompt, the input item in which the input of the value is not necessary. Accordingly, the list of input items includes the title, the subtitle, the author, the publisher, and the description of cover appearance. The number of input items is five.

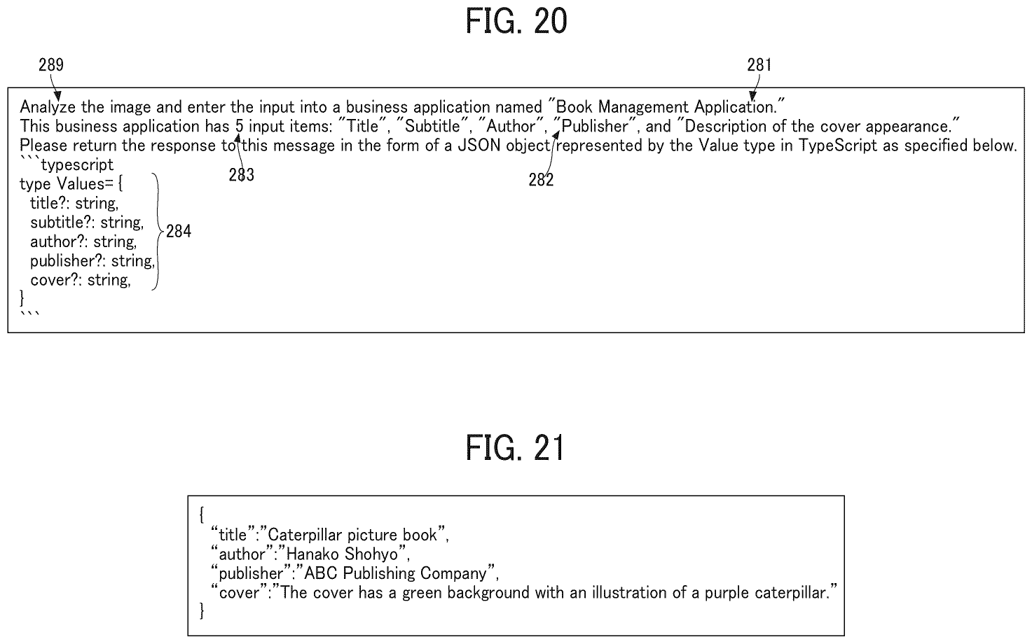

FIG. 20 is a diagram illustrating a prompt generated by the request generation unit 14. The prompt includes a phrase “book management application” 281, a phrase “title, subtitle, author, publisher, description of cover appearance” 282, a value “5” 283, and a data format 284. The following information is set in the placeholder ${appName} 251, the placeholder ${labels.join( )} 252, and the placeholder ${labels.length} 253 illustrated in FIG. 12.

The phrase “book management application” 281 is set in the placeholder ${appName} 251.

The phrase “title, subtitle, author, publisher, description of cover appearance” 282 is set in the placeholder ${labels.join( )} 252.

The value “5” 283 is set in the placeholder ${labels.length} 253.

The data format 284 of each input item is set in the placeholder ${type} 254 illustrated in FIG. 12.
“title?: string,
subtitle?: string,
author?: string,
publisher?: string,
cover?: string”

The instructions described above are the values of the item name and the item type in the information on the input items in FIG. 19. The item name of the data format 284 is arranged in the same order as the phrase “title, subtitle, author, publisher, description of cover appearance” 282.

Since the user terminal 10 transmits the values of the input items returned by the generative AI system 50 to the application service 40, the item name of the data format 264 is not the item label. The application service 40 identifies the input items using the values of the item name, not using the values of the item label. However, the values of the item label may be used. In this case, the request generation unit 14 converts the item label into the item name when values are set to the application service 40.

The symbol “?” at the end of the item name indicates that the generative AI system 50 may omit an input item when there is an input item whose value is not found in the image data. The “string” of the data format 284 is a value (data type) of the item “type.”

The generative AI system 50 interprets that the image data specified by the parameter 245 included in the request message is to be analyzed, by the phrase “analyze the image” 289 at the beginning of the prompt. Subsequently, the generative AI system 50 attempts to generate the values of the phrase “title, subtitle, author, publisher, description of cover appearance” 282 from the image data. Subsequently, the generative AI system 50 determines the input item for which the value has been generated based on the arrangement order of the data format 284, and associates the input item with the generated value.

FIG. 21 is a diagram illustrating a response message of the generative AI system 50 in response to the request message of FIG. 20. The generative AI system 50 analyzes the image data of the cover or the back cover to obtain values corresponding to the phrase “title, subtitle, author, publisher, description of cover appearance” 282. Then, the generative AI system 50 returns the values in association with the item name (described “input item” in the following description) included in the data format 284 of the prompt.
input item: Value
title: Caterpillar picture book
author: Hanako Shohyo
publisher: ABC Publishing Company
cover: The cover has a green background with an illustration of a purple caterpillar.

In this case, since the subtitle included in the data format 284 of the prompt is not included in the image data of the cover or the back cover or the generative AI system 50 cannot detect this information from the business card, this information is not included in the request message.

The string corresponding to the “cover”, which is “The cover has a green background with an illustration of a purple caterpillar.”, is not included as a character in the image data. This string is obtained by the generative AI system 50 converting what kind of image data is into text data. As a result, the information processing system 100 can automatically set information that is not included as characters in the image data in the application service 40.

The user terminal 10 uses the response message of FIG. 21 to request the application service 40 to set the values obtained from the generative AI system 50 in the book management application.

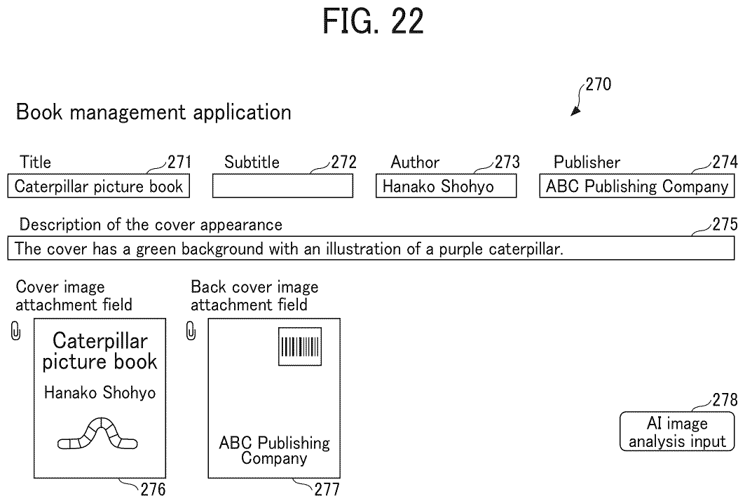

FIG. 22 is a diagram illustrating the input screen 270 of the book management application with values set in the book management application. The values included in the response message of FIG. 21 are set in the corresponding input items, respectively. The input processing unit 16 inputs the values corresponding to the input items into the respective input fields of those input items. In other words, the values are set in the title field 271, the author field 273, the publisher field 274, and the description of cover appearance 275, respectively.

The values input to the input items by the input processing unit 16 can be manually edited by the user. When the user presses a button for registration on the input screen 270 of the book management application, the process of step S10 in FIG. 10 is executed.

As described above, the user can specify multiple pieces of image data of a book to automatically set the values obtained by analyzing the multiple pieces of image data of the book to the corresponding input items. Since the user terminal 10 obtains information on an application from the application service 40, the user terminal 10 can also set appropriate values extracted from image data to input items of any application that is not limited to the book management application.

In the information processing system 100, the user specifies image data including values of input items, and thus the generative AI system 50 can automatically set the values obtained by analyzing the image data to the input items. Since the user terminal 10 obtains information on an application from the application service 40, the user terminal 10 can set appropriate values extracted from image data to input items of any application that is not limited to a specific application.

### Second Embodiment

A description is given below of the information processing system 100 that uses a function call function provided by the generative AI system 50 to set values to input items.

In the second embodiment, the hardware configuration diagram of FIG. 6 and the functional block diagram of FIG. 7 described in the first embodiment can be referred.

The generative AI system 50 may have a function call function. The user terminal 10 specifies a function and a format of arguments of the function to the generative AI system 50, and the generative AI system 50 generates the arguments of the function in the specified format. This function described above is called a function call function. However, a function to be called is not implemented in the user terminal 10 or the application service 40. Although there is no problem even if the function is implemented in the user terminal 10 or the application service 40, in the present embodiment, the function is not implemented in the user terminal 10 or the application service 40 and thus the function to be called is referred to as a dummy function. Even when the term “function call function” is used, it does not imply that the generative AI system 50 performs an actual function call on the user terminal 10 or the application service 40. The user terminal 10 uses the function call function to specify a function and a format of arguments of the function to the generative AI system 50 in order to more reliably obtain values of input items from the generative AI system 50 in the format specified by the user terminal 10.

When the user terminal 10 uses the function call function, the accuracy of returning values in JSON format by the generative AI system 50 can be enhanced as compared with a case where the user terminal 10 requests the generative AI system 50 to generate input items and values of the input items in the JSON format and the generative AI system 50 generates the values.

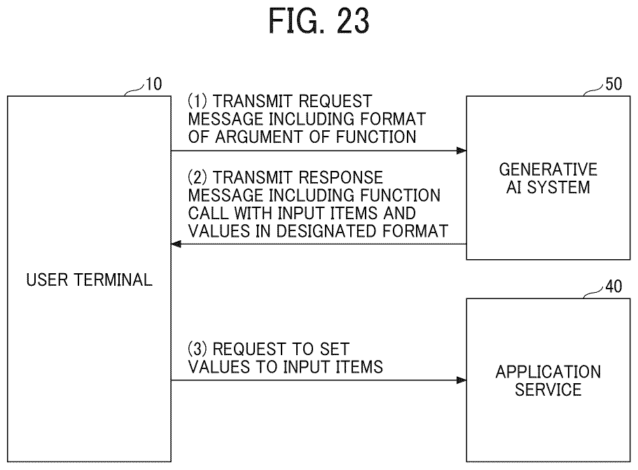

FIG. 23 is a diagram illustrating a method of setting values of input items using the function call function. It is assumed that the user terminal 10 generates a request message for the generative AI system 50.

In step (1), the user terminal 10 transmits a request message including a format of arguments of a function. A function refers to a programming interface that performs a predetermined process with specified arguments and returns a return value as a result. However, in this case, the function is not implemented in the user terminal 10 and the application service 40. When the user terminal 10 includes the format in the request message to transmit the format of the arguments of the function (dummy function) to the generative AI system 50, it is expected that the values of the input items are included in the format specified by the user terminal 10 in the function call from the generative AI system 50.

The request from the generative AI system 50 to the user terminal 10 for calling the dummy function that is not actually implemented is referred to as a function call (tool_call in the present embodiment).

There is no problem even if the function is actually implemented in the user terminal 10 or the application service 40, and the user terminal 10 may execute the function to set the values in the application service 40.

The user terminal 10 may not include the format of the arguments of the function in the same request message as the information regarding the application. For example, the user terminal 10 may include the format of the arguments of the function in a request message to transmit the request message to the generative AI system 50 different from the request message including the information on the application.

In step (2), the generative AI system 50 transmits a response message including a function call (tool_call) to the user terminal 10 based on the information regarding the application included in the transmitted request message and the format of the arguments of the function. Even if the generative AI system 50 requests the user terminal 10 to call a function, the generative AI system 50 does not request the execution of the function to the user terminal 10, and the generative AI system 50 only proposes the values of the input items in the specified format.

In other words, the generative AI system 50 includes the input items and the values of the application transmitted from the user terminal 10 in the response message as arguments of the function. The generative AI system 50 analyzes information on the application to generate these values.

In step (3), the user terminal 10 obtains the input items and the values included in the function call (tool_call) included in the response message transmitted from the generative AI system 50, and requests the application service 40 to set the values to the input items. Specifically, the user terminal 10 generates a request message for calling the API of the application service 40 and transmits the generated request message to the application service 40. The user terminal 10 sets the values of the input items in the application service 40 in response to the function call (the user terminal 10 does not execute the called function).

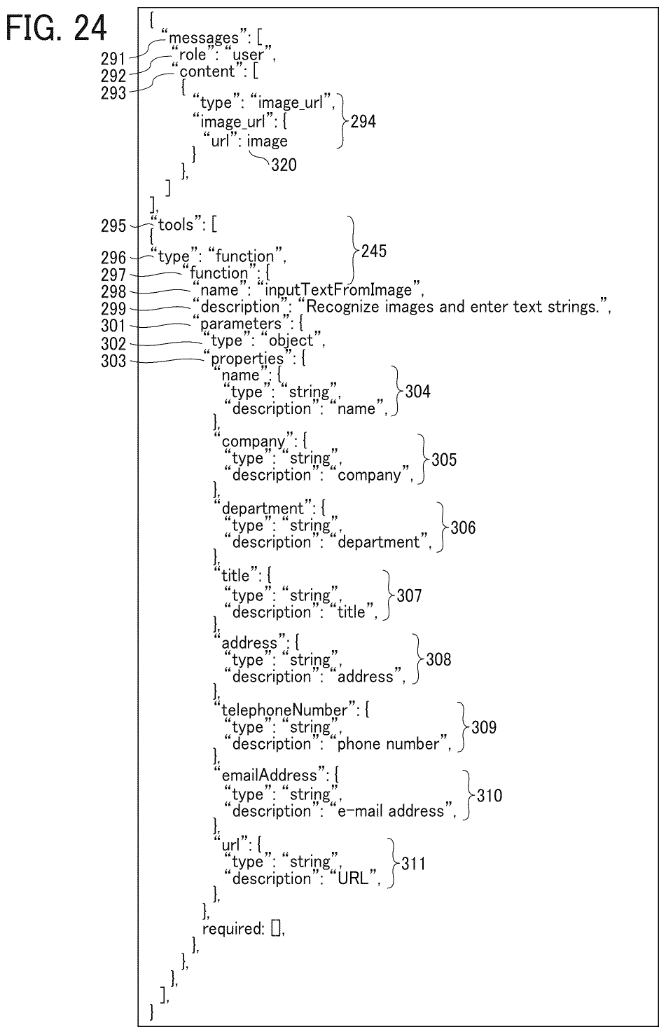

FIG. 24 is a diagram illustrating a request message including arguments of a function. The request message includes a “messages” key 291 and a “tools” key 295. The “messages” key 291 includes a “role” key 292, a “content” key 293, a parameter 294, and an image 320. The “tools” key 295 includes a “type” key 296, a “function” key 297, a “name” key 298, a “description” key 299, a “parameters” key 301, a “type” key 302, a “properties” key 303, a “name” parameter 304, a “company” parameter 305, a “department” parameter 306, a “title” parameter 307, an “address” parameter 308, a “telephoneNumber” parameter 309, an “emailAddress” parameter 310, and a “url” parameter 311. The request message in FIG. 24 is assumed to be a business card management application. The “messages” key 291, the “role” key 292, and the “content” key 293 are the same as described in FIG. 11. The parameter 294 describes that the “type” of the input item is set to a value “image_url”, and the value “image_url” is set to the image 320. The image 320 is set to, for example, a URL or a Base64-encoded image of a business card.

The parameter 244 (prompt) of FIG. 11 is replaced with the “tools” key 295.

The “tools” key 295 is an API of the generative AI system 50, and the description below specifies the format of arguments of function used in the “tools” key 295.

The value of the “type” key 296 is set to “function”, indicating that the object is of type function.

The value of the “function” key 297 includes a description related to the function. The value of the “name” key 298 includes the name of the function. The value of the “description” key 299 includes the functionality of the function. The request generation unit 14 stores both values of the value of the “name” key 298 and the “description” key 299 in advance. The value of the “parameters” key 301 includes a description of the arguments of the function. The value of the “type” key 302 is set to “object”, indicating that the arguments are described in object format. The “function” key 297, the “name” key 298, the “description” key 299, and the “parameters” key 301 are all APIs of the generative AI system 50.

The values of the “properties” key 303 include a list of information on input items of the business card management application in a nest structure in JSON format. In other words, the “properties” key 303 requests the generative AI system 50 to return the arguments of the function in JSON format.

The values of the “name” parameter 304 specifies how to return a value for the input item “name.” Each parameter from the “name” parameter 304 to the “url” parameter 311 includes a “name” key and a “description” key. The “name” key of each parameter is obtained from the item name of the information on the input item. Thus, the “name” parameter 304 specifies that the “type” key of the input item “name” is “string.” The “description” key of the “name” parameter 304 specifies that “name” is returned to the input item “name.” The “name” indicates that the generative AI system 50 is expected to analyze the image data and return information identified as a name based on the analysis.

The same applies to the following input items, namely, the “company” parameter 305, the “department” parameter 306, the “title” parameter 307, the “address” parameter 308, the “telephoneNumber” parameter 309, the “emailAddress” parameter 310, and the “url” parameter 311.

As described above, the “tools” key 295 includes a list of input items among the information on the application. The image data is included in the parameter 245 in FIG. 11 as in the same manner of the first embodiment. The request message in FIG. 24 does not include an application name but may include an application name. On the other hand, the “name” key 298 or the “description” key 299 serves as an application name, and may be regarded as application name.

The generative AI system 50 interprets that the image data specified by the parameter 245 included in the request message is to be analyzed, by the “name” key 298 or the “description” key 299. Subsequently, the generative AI system 50 attempts to generate the values (name, company, department, title, addresses, phone number, e-mail address, URL) specified by the “name” parameter 304, the “company” parameter 305, the “department” parameter 306, the “title” parameter 307, the “address” parameter 308, the “telephoneNumber” parameter 309, the “emailAddress” parameter 310, and the “url” parameter 311. Subsequently, the generative AI system 50 returns the generated values in JSON format.

FIG. 25 is a diagram illustrating a response message from the generative AI system 50 in a case where the generative AI system 50 has a function call function. The response message includes a “messages” key 321, a “role” key 322, a “content” key 323, a “tool_calls” key 324, a “type” key 325, a “function” key 326, a “name” key 327, and an “arguments” key 328. The “messages” key 321, the “role” key 322, and the “content” key 323 are the same as described in FIG. 13. In the response message of FIG. 25, the generative AI system 50 requests the user terminal 10 to call a function.

The tool_calls 324 indicates that the following description is a function call. In other words, the generative AI system 50 requests the user terminal 10 to call a dummy function that is not actually implemented. However, a function may actually be implemented in the user terminal 10.

The value of the “type” key 325 is set to “function”, indicating that the object is of type function.

The value of the “function” key 326 includes a description related to the function.

The “name” key 327 is the name of the function.

The “arguments” key 328 indicates the arguments of the function. The arguments include the following input items and values. In other words, the generative AI system 50 analyzes the image data of the business card, and generates the name items (input items) and the values in association with each other in JSON format specified in the “properties” key 303 of FIG. 24.
input item: Value
name: Taro Tokkyo
company: Sample 1 corporation
department: Sales department
URL: https://sample1.co.jp

These input items and values described above match the information included in the response message of FIG. 16 of the first embodiment. The user terminal 10 uses the response message of FIG. 25 to request the application service 40 to set the values obtained from the generative AI system 50 in the business card management application. As a result, as illustrated in FIG. 17, the values of the input items are set in the input screen 210 of the business card management application.

In addition to the effects of the first embodiment, the generative AI system 50 can enhance the accuracy of returning values in JSON format. Since the user terminal 10 can obtain the values of the input items in JSON format, the values of the input items can be securely set in the application service 40.

### Third Embodiment

In the present embodiment, a description is given below of a modification common to the first embodiment and the second embodiment.

One record of an application may include a plurality of pieces of image data. For example, in the case of a business card management application, there is a case where a business card image attachment field and a face image attachment field are provided. Since the image data in the face image attachment field is a face image of a customer, the values of the input items are not included. In this case, when the generative AI system 50 analyzes the face image of the customer, the cost increases in terms of both time and processing load. When the generative AI system 50 is charged on a pay-as-you-go basis, additional cost is incurred.

Given this situation, it is effective to enable the user to select image data to be used for the AI image analysis input on the input screen 210 of the business card management application.

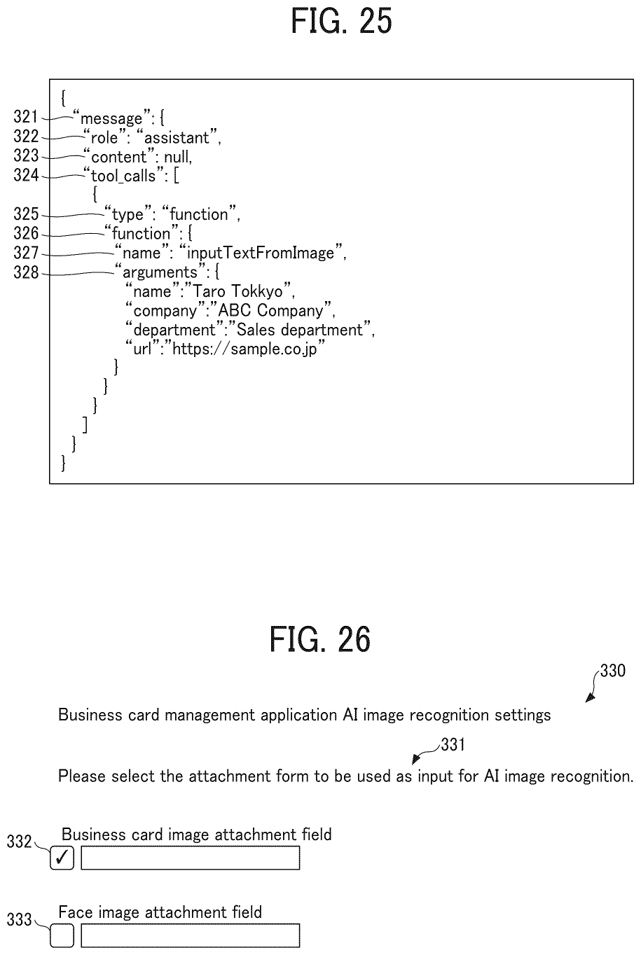

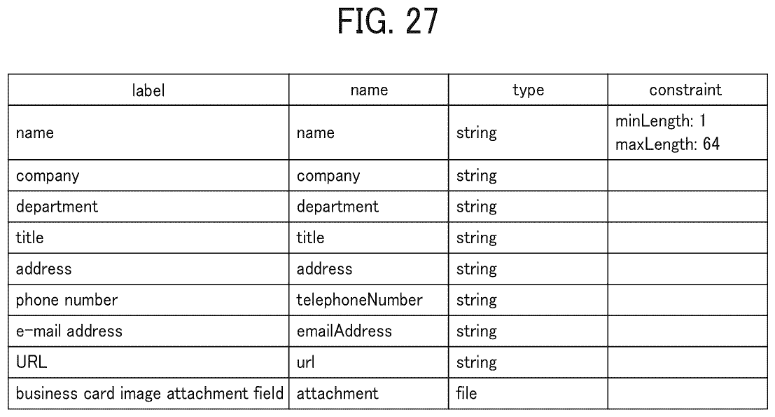

FIG. 26 is a diagram illustrating an image data selection screen 330 displayed by the user terminal 10 as a part of the input screen 210 of the business card management application or as a pop-up screen. When the AI image analysis input button 228 is pressed, the image data selection screen 330 is displayed as a pop-up screen. The image data selection screen 330 includes a message 351 stating “Please select the attachment form to be used as input for AI image recognition.” In a case where the business card management application includes the business card image attachment field and the face image attachment field, the image data selection screen 330 includes a checkbox 332 for selecting the business card image attachment field and a checkbox 333 for selecting the face image attachment field. In this case, the user causes the generative AI system 50 to analyze only the image data of the business card image attachment field. Accordingly, the user selects the checkbox 332 for selecting the business card image attachment field.

Accordingly, the request message generated by the request generation unit 14 in step S8 of FIG. 10 includes only the image data of the business card image attachment field for which the checkbox 332 is checked. As a result, the content of the prompt is the same as the prompt of FIG. 15.

Some input items of an application may have an input range.

For example, in the case of an input item in which a character string is used as a data format, the maximum number of characters and the minimum number of characters that can be input may be determined. In the case of an input item having a numerical value, the maximum value and the minimum value that can be input may be determined.

FIG. 27 is a diagram illustrating information on input items having an input range. As compared with FIG. 9, the information on the input items of FIG. 27 includes an item constraint. The item constraint defines an input range for the value of the input item. For example, in the input item in which the item label is “name”, the input range is set such that the minimum number of characters (minLength) is one and the maximum number of characters (maxLength) is 64.

When the request generation unit 14 generates the prompt, the request generation unit 14 also includes the information of the input range in the prompt. This prevents the value generated by the generative AI system 50 from being out of the input range of the application.

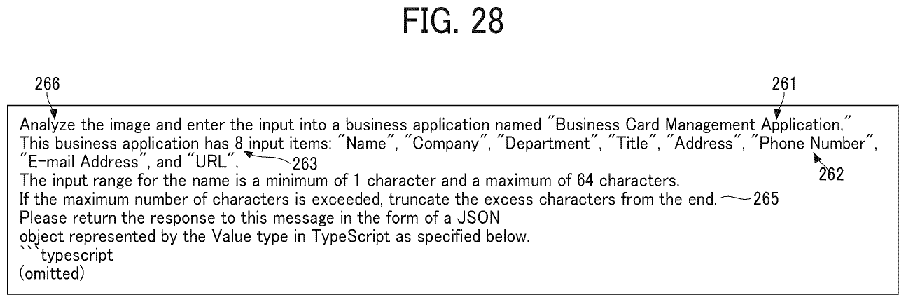

FIG. 28 is a diagram illustrating a prompt for requesting values of input items in JSON format without using a function call. The description given in reference to FIG. 28 mainly describes the differences from FIG. 15. The prompt in FIG. 28 additionally includes text data 265 stating “The input range for the name is a minimum of 1 character and a maximum of 64 characters. When the maximum number of characters is exceeded, truncate the excess characters from the end.” The “1” and “64” indicating the number of characters in the text data 265 are changed based on the item constraint of the information on the input items in FIG. 27.

In other words, placeholders ${ . . . } corresponding to the maximum number of characters and the minimum number of characters are set in the template of FIG. 12 as follows. “The input range for the name is a minimum of ${minLength} character and a maximum of ${maxLength} characters. If the maximum number of characters is exceeded, truncate the excess characters from the end.” The request generation unit 14 replaces ${minLength} with “1” and replaces ${maxLength} with “64.” The text data 265 other than “1” and “64” is a fixed phrase.

The generative AI system 50 analyzes the text data 265 included in the prompt to generate values such that the value generated for “name” is not outside of the input range.

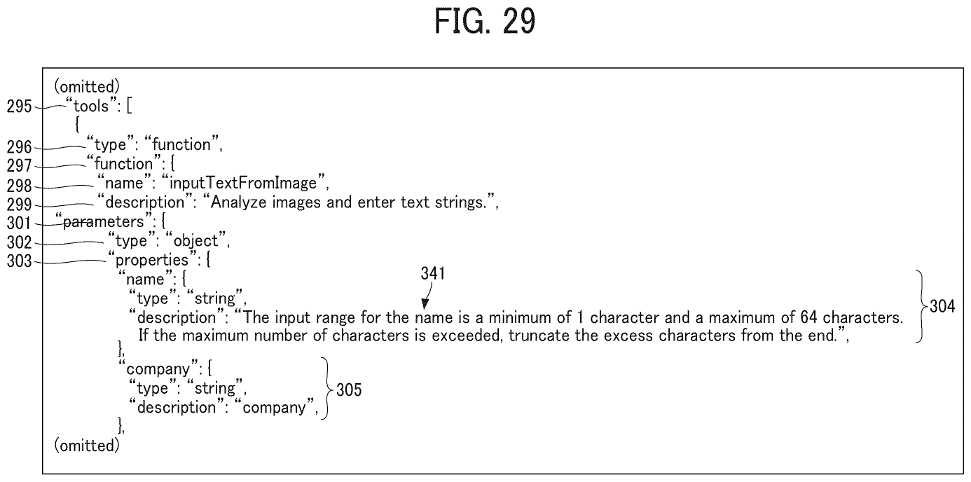

FIG. 29 is a diagram illustrating a request message when the generative AI system 50 has a function call function. The description given in reference to FIG. 29 mainly includes the differences from FIG. 24. In FIG. 29, text data 341 is added to the “name” parameter 304.

The text data 341 is “The input range for the name is a minimum of 1 character and a maximum of 64 characters. If the maximum number of characters is exceeded, truncate the excess characters from the end.” The text data 341 specifies that there is an input range for “name” and an operation to be performed when the input exceeds the input range.

The generative AI system 50 analyzes the description (i.e., the input is within the input range and the operation in a case where the input exceeds the input range) regarding the arguments of the function, and generates values such that the value of the “name” key of the “properties” key to be generated does not exceed the input range.

In addition to the input range, a data format of a date (e.g., YYYY/MM/DD), a data format of a time (e.g., hhmmss), a data format of a phone number (e.g., whether the phone number includes a hyphen), a data format of a facsimile number (e.g., whether the facsimile number includes a hyphen), a data format of a zip code (e.g., whether the zip code includes a hyphen), a data format of an address (e.g., whether the address includes a hyphen in “chome-ban-go”), or a data format of an e-mail address (e.g., including only one @) may be determined.

In addition to the effects of the first embodiment and the second embodiment, it is possible to prevent the values generated by the generative AI system 50 from being out of the input range of the application.

The generative AI system 50 includes a technique called few-shot prompting that provides prompt with several examples of output to enhance the accuracy of the generation of values. The generative AI system 50 can perform the few-shot prompting to enhance the accuracy of generation of the values of the input items.

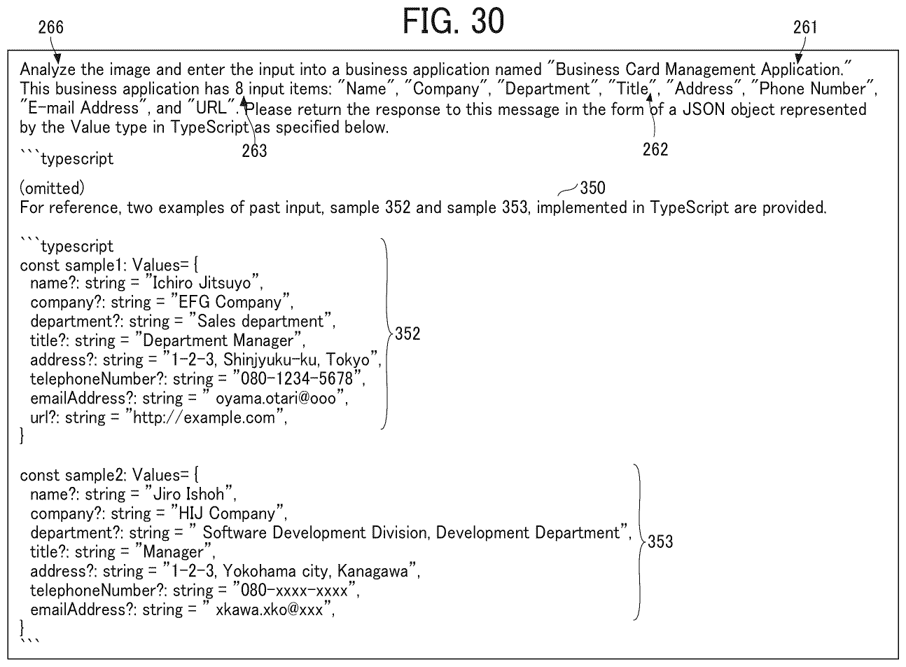

FIG. 30 is a diagram illustrating a prompt using the few-shot prompting. Since the few-shot prompting is a technique of including one or more output examples in a prompt, the request generation unit 14 includes information (FIG. 8) already registered in the application service 40 in the prompt of FIG. 30. The description given in reference to FIG. 30 mainly includes the differences from FIG. 15.

The prompt of FIG. 30 includes a message 350 stating “For reference, two examples of past input, a sample 352 and a sample 353, implemented in TypeScript are provided.” The message 350 informs the generative AI system 50 that the following is information registered in the application, and the user wants to refer to the information.

The prompt of FIG. 30 includes the sample 352 indicating that the content of the sample 352 is the first input content. In the sample 352, values of one record of information already registered in the application are described in association with the item name which is information on the input items.

The prompt of FIG. 30 includes the sample 353 indicating that the content of the sample 353 is the second input content. In the sample 353, values of one record of information already registered in the application are described in association with the item name which is information on the input items.

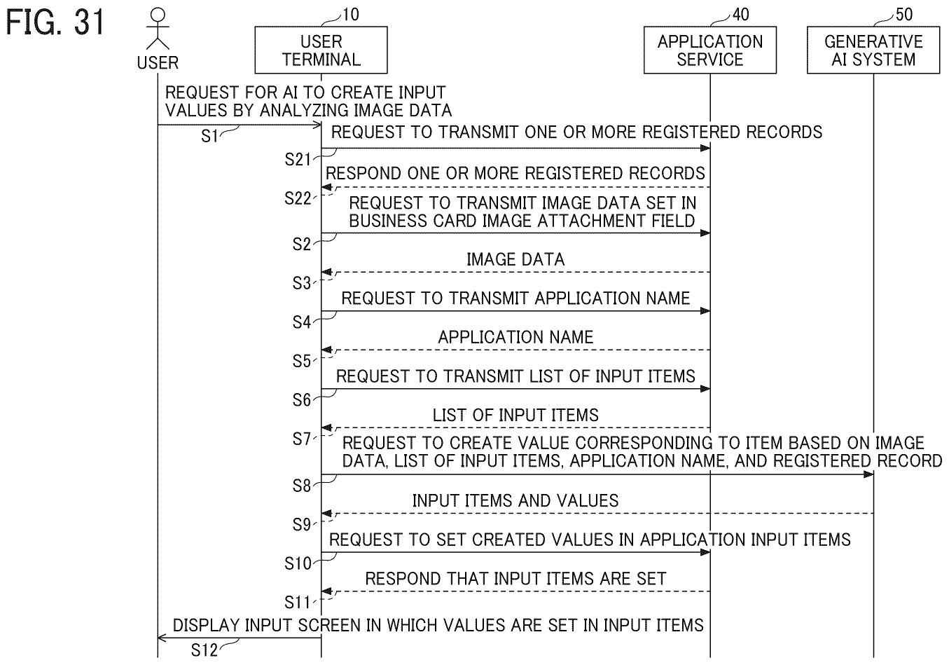

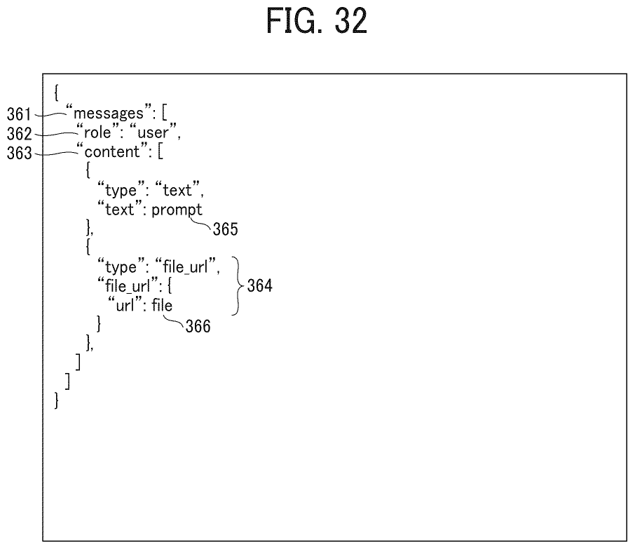

FIG. 31 is a sequence diagram illustrating a process performed by the information processing system 100 when the few-shot prompting is used. The description given in reference to FIG. 31 mainly includes the differences from FIG. 10. In FIG. 31, steps S21 and S22 are added. A part of the processing of the steps S8 and S9 is changed.

In step S21, the request generation unit 14 of the user terminal 10 specifies the identification information of the application to request the application service 40 to transmit one or more records of information registered in the application in the past.

In step S22, the communication unit 41 of the application service 40 receives the request. The registration unit 43 obtains one or more samples of the information registered in the application from the application information storage unit 49, and the communication unit 41 transmits one or more records to the user terminal 10.

In step S8, the request generation unit 14 of the user terminal 10 generates a request message (image data of the business card, application name, list of input items, and one or more records). The request transmission unit 15 transmits the request message to the generative AI system 50.

In step S9, the generative AI system 50 analyzes the image of the business card to generate values from the image and adjusts the number of characters in the values by reference to one or more records. The generative AI system 50 determines which input items the generated values correspond to. The generative AI system 50 transmits a response message (the input items and the corresponding values) to the user terminal 10. The reception unit 11a of the user terminal 10 receives the values corresponded to the input items.

The subsequent processing in steps S10 and S11 is performed in the same or substantially the same manner as steps S10 and S11 of FIG. 10.

By performing the few-shot prompting, the generative AI system 50 can easily determine values to be corresponded to input items, and the accuracy of generation of the values can be enhanced. As a result, the user terminal 10 can easily obtain the values corresponding to the input items.

In addition to the effects of the first embodiment and the second embodiment, the few-shot prompting can enhance the accuracy of generating values for the input items.

The generative AI system 50 can analyze a file in a format such as document data, video data, or speech data, in addition to text data and image data. When the values of the input items are generated, the user terminal 10 can transmit document data, video data, and speech data to the generative AI system 50 in the same manner as image data.

FIG. 32 is a diagram illustrating a request message transmitted from the user terminal 10 to the generative AI system 50. The request message includes a “messages” key 361, a “role” key 362, a “content” key 363, and parameters 365 and 367. The description given in reference to FIG. 32 mainly describes the differences from FIG. 11. The “messages” key 361, the “role” key 362, and the “content” 363 are the same as described in FIG. 11. Each of the parameters 365 and 367 includes a “type” key and its value in a set. A “type” key of the parameter 364 is newly set to “file_url.” When the “type” is set to “file_url,” the value of a “url” key is a “file” 366. The “file” 366 is set to, for example, a URL where the file is stored or a Base64-encoded image.

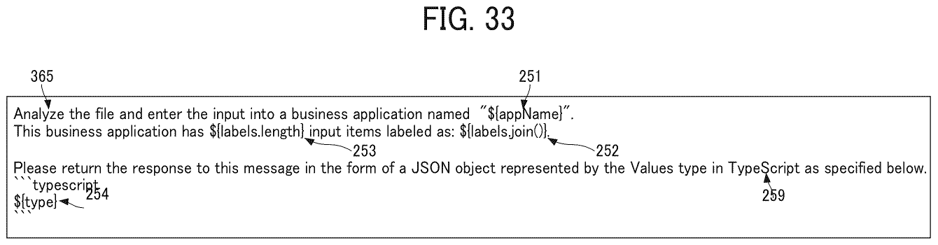

FIG. 33 is a diagram illustrating character strings used as a prompt, which is set in the prompt 365 of FIG. 32. The prompt includes a phrase “analyze the file” 365. The description given in reference to FIG. 33 mainly describes the differences from FIG. 12. The difference between the beginning of prompt of FIG. 33 and FIG. 12 is “analyze the image” and “analyze the file.” When the generative AI system 50 analyzes the prompt, the generative AI system 50 interprets that the “file” is recognized, and determines analyzes the “file” included in the request message to generate the values of the input items of the business card management application.

As described above, the request generation unit 14 changes the description of the prompt, and thus the format of the data to be analyzed by the generative AI system 50 can be changed. For example, in the case of video data, the generative AI system 50 can generate the values of the input items even when the business card is captured as a video image. In the case of document data, the generative AI system 50 can generate the value of the input item even when a name is included in prose or a form. In the case of speech data, the generative AI system 50 can generate the values of the input items even when a name is included in conversations.

Since a plurality of files can be specified in the prompt, the request generation unit 14 may include two or more of the image data, the document data, the video data, and the speech data in one prompt and transmit the prompt to the generative AI system 50. In this case, the phrase “analyze the file” at the beginning of the prompt of FIG. 33 is changed to “analyze the image, the document, the video, and the speech.”

In addition to the effects of the first embodiment and the second embodiment, the generative AI system 50 can analyze a file of text data or image data and generate values of input items.

The embodiments described above are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, although the user terminal 10 transmits image data to the generative AI system 50, the image data may be stored on a predetermined server. In this case, the user terminal 10 transmits information for designating the image data on the server to the generative AI system 50. The generative AI system 50 obtains the image data from the server and generates the values of the input items.

Although the values of the input items generated by the generative AI system 50 are in JSON format, the values of the input items may be in another format such as XML or comma separated values (CSV).

The user terminal 10 sets the generated values in the input items of the application managed by the application service 40. However, the user terminal 10 may set the generated values to the input items of the native application that operates in the user terminal 10. For example, when the user terminal 10 is executing a spreadsheet application, the generated values may be set in cells of the spreadsheet application.

The apparatuses or devices described in the embodiments described above are merely one example of a plurality of computing environments that implement the embodiments disclosed herein. In some embodiments, the application service 40 includes a plurality of computing devices, such as a server cluster. The computing devices are configured to communicate with one another through any type of communication link including, for example, a network or a shared memory, and perform the processes disclosed in the present specification.

The application service 40 can be configured to share the disclosed processing steps, for example, the processes illustrated in FIG. 10, in various combinations. For example, a process executed by a predetermined unit may be executed by a plurality of information processing devices included in the application service 40. The application service 40 may be integrated in one server apparatus or may be divided into a plurality of apparatuses.

The configuration illustrated in, for example, FIG. 7 is divided according to main functions in order to facilitate understanding of processing by the application service 40. The scope of the present disclosure is not limited by how the process units are divided or by the names of the process units. The processes implemented by the application service 40 can be divided to a larger number of processes depending on the contents of processes. One process may be divided to include the larger number of processes.

The functions of the embodiments described above may be implemented by one or a plurality of processing circuits. The “processing circuit” in the present specification includes a processor programmed to execute each function by software like a processor implemented by an electronic circuit, and a device such as an application-specific integrated circuit (ASIC), a digital signal processor (DSP), a field-programmable gate array (FPGA), or a conventional circuit module designed to execute each function described above.

Embodiments of the present disclosure provide significant enhancements in computer capabilities and functionality. These enhancements allow users to utilize computers that provide more efficient and robust interaction with tables, which are a way to store and present information on information processing apparatuses. Embodiments of the present disclosures provide a better user experience through the use of a more efficient, powerful, and robust user interface. Such a user interface provides a better interaction between a human and a machine.

A description is given below of some aspects of the present disclosure.

### Aspect 1

An information processing apparatus communicates with a server apparatus that manages information input to an input field of an input item by a user and a generative AI system via a network. The information processing apparatus includes a display control unit, a request transmission unit, a reception unit, an input processing unit, and a transmission unit. The display control unit displays a screen that receives an input of information to the input field from the user. The screen can receive an instruction to extract information to be input to the input field from image data. When the instruction is received on the screen, the request transmission unit transmits, to the generative AI system, a request including the image data from which information is to be extracted and an instruction to extract information corresponding to the input item from the image data. The reception unit receives the information corresponding to the input item transmitted from the generative AI system. The input processing unit inputs the received information corresponding to the input item to the input field of the corresponding input item. The transmission unit transmits the information corresponding to the input item input to the input field to the server apparatus in order for the server apparatus to manage the information.

### Aspect 2

In the information processing apparatus according to Aspect 1, the request transmission unit further transmits, to the generative AI system, information for calling a function that causes the input processing unit to perform. The reception unit receives information for designating the function and the information corresponding to the input item from the generative AI system. The input processing unit executes the function to input the received information corresponding to the input item to the input field of the corresponding input item.

### Aspect 3

In the information processing apparatus according to Aspect 1, the request transmission unit further transmits information for calling a dummy function that is not implemented to the generative AI system. The reception unit receives information for designating the dummy function and the information corresponding to the input item from the generative AI system. The input processing unit inputs the received information corresponding to the input item to the input field of the corresponding input item.

### Aspect 4

In the information processing apparatus according to any one of Aspects 1 to 3, the display control unit displays the screen in which the information corresponding to the input item is input to the input field of the input item by the input processing unit.

### Aspect 5

In the information processing apparatus according to any one of Aspects 1 to 4, the screen is a screen for accepting upload of the image data. The information processing apparatus further includes an identification unit to identify the uploaded image data as image data to be extracted.

### Aspect 6

In the information processing apparatus according to Aspect 5, the server apparatus is a server apparatus that provides an application that manages information input by the user to the input field of the input item. The reception unit further receives information for identifying an application selected by the user, and the identification unit identifies the input item based on the information for identifying the application.

### Aspect 7

In the information processing apparatus according to Aspect 3, the information processing apparatus further includes a request generation unit to generate the request.

### Aspect 8

In the information processing apparatus according to any one of Aspects 1 to 7, the request transmission unit transmits, to the generative AI system, a data format of the input item and an instruction to extract information described in the data format of the input item.

### Aspect 9

In the information processing apparatus according to any one of Aspects 1 to 8, the server apparatus is a server apparatus that provides an application that manages information input by the user to the input field of the input item. The request transmission unit transmits the request including a list of the input items and a name of the application to the generative AI system.

### Aspect 10

In the information processing apparatus according to Aspect 5, the server apparatus is a server apparatus that provides an application that manages information input by the user to the input field of the input item. The application is an application generated by receiving a setting of the input item from the user.

### Aspect 11

In the information processing apparatus according to Aspect 5, the server apparatus is a server apparatus that provides an application that manages information input by the user to the input field of the input item. The identification unit includes an image identification unit, an input-item identification unit, and an application identification unit. The image identification unit specifies the image data uploaded by the user. The input-item identification unit specifies the input item corresponding to the application. The application identification unit specifies an application name of the application.

### Aspect 12

In the information processing apparatus according to Aspect 7, the transmission unit transmits a request from one or more programs to be executed by the information processing apparatus to the server apparatus. The information processing apparatus is capable of executing a web browser. The web browser executes the program transmitted from the server apparatus to operate the reception unit, the transmission unit, the request generation unit, the request transmission unit, and the input processing unit.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or DVD, and/or the memory of an FPGA or ASIC.

1. An information processing apparatus communicably connected with a server apparatus and a generative AI system via a network, the information processing apparatus comprising:
processing circuitry configured to:
display a screen that receives an input of information to an input field of an input item from a user and receives an instruction to extract information to be input to the input field from image data;
when the instruction is received on the screen, transmit, to the generative AI system, a request including the image data from which the information is to be extracted and an instruction to extract the information corresponding to the input item from the image data;
receive the information corresponding to the input item transmitted from the generative AI system;
input the received information corresponding to the input item to the input field of the input item; and
transmit the information corresponding to the input item input to the input field to the server apparatus to cause the server apparatus to manage the information.

2. The information processing apparatus according to claim 1, wherein the processing circuitry is further configured to
transmit, to the generative AI system, information for calling a function that causes the processing circuitry to input the received information to the input field,
receive information for designating the function and the information corresponding to the input item from the generative AI system, and
execute the function to input the received information corresponding to the input item to the input field of the input item.

3. The information processing apparatus according to claim 1, wherein the processing circuitry is further configured to
transmit, to the generative AI system, information for calling a dummy function that is not implemented,
receive, from the generative AI system, information for designating the dummy function and the information corresponding to the input item, and
input the received information corresponding to the input item to the input field of the input item.

4. The information processing apparatus according to claim 1,
wherein the processing circuitry is configured to display the screen in which the information corresponding to the input item is input to the input field of the input item.

5. The information processing apparatus according to claim 1,
wherein the screen is a screen for accepting upload of the image data, and
wherein the processing circuitry is configured to identify the uploaded image data as the image data from which the information is to be extracted.

6. The information processing apparatus according to claim 5,
wherein the server apparatus is an apparatus that provides an application that manages the information input by the user to the input field of the input item, and
wherein the processing circuitry is configured to further receive information for identifying an application selected by the user and identify the input item based on the information for identifying the application.

7. The information processing apparatus according to claim 3,
wherein the processing circuitry is configured to generate the request.

8. The information processing apparatus according to claim 1,
wherein the processing circuitry is configured to transmit, to the generative AI system, a data format of the input item and an instruction to extract information described in the data format of the input item.

9. The information processing apparatus according to claim 8,
wherein the server apparatus is an apparatus that provides an application that manages information input by the user to the input field of the input item; and
wherein the processing circuitry is configured to transmit the request including a list of the input items and a name of the application to the generative AI system.

10. The information processing apparatus according to claim 1,
wherein the server apparatus is an apparatus that provides an application that manages information input by the user to the input field of the input item; and
wherein the application is an application created by receiving a setting of the input item from the user.

11. The information processing apparatus according to claim 5,
wherein the server apparatus is an apparatus that provides an application that manages information input by the user to the input field of the input item,
wherein the processing circuitry is configured to:
specify the image data uploaded by the user;
specify the input item corresponding to the application; and
specify an application name of the application.

12. The information processing apparatus according to claim 7,
wherein the processing circuitry is configured to transmit, to the server apparatus, a request for one or more programs to be executed by the information processing apparatus,
execute, with a web browser, the one or more programs transmitted from the server apparatus to operate.

13. The information processing apparatus according to claim 1,
wherein the processing circuitry is configured to:
transmit a request for a program;
receive the program in response to the request for the program; and
execute the program to display the screen, transmit the request to the generative AI system, receive the information from the generative AI system, input the received information to the input field, and transmit the information to the server apparatus.

14. An information processing system comprising:
a server apparatus; and
an information processing apparatus configured to communicate with a generative AI system via a network,
the information processing apparatus comprising processing circuitry configured to:
display a screen that receives an input of information to an input field of an input item from a user and receives an instruction to extract information to be input to the input field from image data;
when the instruction is received on the screen, transmit, to the generative AI system, a request including the image data from which the information is to be extracted and an instruction to extract the information corresponding to the input item from the image data;
receive the information corresponding to the input item transmitted from the generative AI system;
input the received information corresponding to the input item to the input field of the input item; and
transmit the information corresponding to the input item input to the input field to the server apparatus to cause the server apparatus to manage the information.

15. A non-transitory storage medium storing computer-readable program code that, when executed by one or more processors on an information processing apparatus communicably connected with a server apparatus and a generative AI system via a network, causes the one or more processors to perform a method, the method comprising:
displaying a screen that receives an input of information to an input field of an input item from a user and receives an instruction to extract information to be input to the input field from image data;
when the instruction is received on the screen, transmitting, to the generative AI system, a request including the image data from which the information is to be extracted and an instruction to extract the information corresponding to the input item from the image data;
receiving the information corresponding to the input item transmitted from the generative AI system;
inputting the received information corresponding to the input item to the input field of the input item; and
transmitting the information corresponding to the input item input to the input field to the server apparatus to cause the server apparatus to manage the information.
